(19) United States
(12) Patent Application Publication
(10) Pub. No.: US 2018/0013782 A1
(43) Pub. Date: Jan. 11, 2018

(54) CONTINUOUS DEVICE/UICC BASED AUTHENTICATION FOR LTE SYSTEMS

(71) Applicant: INTERDIGITAL PATENT HOLDINGS, INC., Wilmington (DE)

(72) Inventors: Vinod Kumar CHOYI, Conshohocken, PA (US); Yogendra C. SHAH, Exton, PA (US); Alec BRUSILOVSKY, Downingtown, PA (US); Li-Hsiang SUN, Smithtown, NY (US); Nobuyuki TAMAKI, Melville, NY (US); Rafael A. CEPEDA, London (GB)

(21) Appl. No.: 15/539,179

(22) PCT Filed: Dec. 23, 2015
(86) PCT No.: PCT/US2015/000429

§ 371 Date: Jun. 23, 2017

Related U.S. Application Data
(60) Provisional application No. 62/096,974, filed on Dec. 26, 2014.
(60) Provisional application No. 62/102,892, filed on Jan. 13, 2015.

(51) Int. Cl. H04L 29/06

(52) U.S. Cl. CPC H04L 63/1433; H04L 63/083; H04L 2463/082

(57) ABSTRACT

An authentication assurance level associated with an entity, for instance a user equipment, may be computed periodically or in response to an event. The authentication assurance level is compared to an authentication threshold. Based on the comparison, it is determined whether a fresh performance of at least one authentication factor needs to be performed. Thus, appropriate authentication factors and functions may be invoked on a periodic basis to maintain a certain authentication assurance level, which is referred to herein as the assurance threshold. The authentication assurance level may change, for instance decay, over time and may be refreshed periodically.

### CROSS REFERENCE TO RELATED APPLICATIONS

This application claims the benefit of U.S. Provisional Patent Application Ser. No. 62/096,974 filed Dec. 26, 2014 and U.S. Provisional Patent Application Ser. No. 62/102,892 filed Jan. 13, 2015, the disclosures of each of which are hereby incorporated by reference as if set forth in their respective entireties herein.

### BACKGROUND

Multi-factor authentication refers to any authentication that uses more than one factor. Multi-factor authentication may be used to strengthen the authentication of a user. An example two-factor authentication is based on a user's identity (ID) and password as a first authentication factor, and a hardware/software-based token as a second authentication factor. A user ID and password may be used to authenticate the user's presence, and the token may confirm the user's possession of the device on which the token functionality resides. Example authentication factors include user identities with corresponding passwords, tokens, and biometrics/behavioral aspects of a user.

Users (or devices) often maintain continuous access to a service, which is provided by a service provider (SP) on a network. For example, a user equipment (UE), using a browser or local application for example, may maintain a persistent connection to a service. While access may be persistent, current approaches often do not require further authentication to be performed after the user is authenticated for initial access, thereby creating a potential security vulnerability. Alternatively, in some cases users are forced to periodically re-authenticate using intrusive mechanisms, which creates an authentication burden for the users.

### SUMMARY

As described herein, the authentication burden on users may be lessened without compromising security. Further, different service providers may periodically authenticate users to their own levels as desired, as described herein. Methods, devices, and systems are disclosed herein that use a multitude of authentication factors and associated authentication functions to perform a continuous authentication, thereby providing a risk-based assurance assessment with reduced friction. Appropriate authentication factors and functions may be invoked on a periodic basis to maintain a certain authentication assurance level (AAL), which is referred to herein as an assurance or authentication threshold (AT) or an authentication assurance threshold. The AAL may decay over time and may be refreshed periodically. In an example embodiment, an authentication assurance level associated with an entity is periodically computed. The authentication assurance level is compared to an authentication threshold. Based on the comparison, it is determined whether one or more fresh authentication factors need to be performed to achieve the AT. The authentication assurance level may decay as a function of time. The authentication threshold may be based on a policy of a network, service, or application network.

### BRIEF DESCRIPTION OF THE DRAWINGS

A more detailed understanding may be had from the following description, given by way of example in conjunction with the accompanying drawings wherein:

FIG. 1 is a block diagram that illustrates interactions between a system that includes a user, services, and a continuous authentication and monitoring entity (CAME);

FIG. 2 is a block diagram of an architecture of continuous authentication functionalities;

FIG. 3 is a call flow that shows an example of a periodic measurement of an authentication assurance level (AAL) in accordance with an example embodiment.

FIG. 4 depicts an example engine that computes the Assurance Level using Time characteristics;

FIG. 5 is a block diagram that shows an example architecture for network-based continuous authentication (NCA);

FIG. 6 is a block diagram that shows an example architecture for device-based continuous authentication (DCA);

FIG. 7 is a call flow that shows an implicit network-based authentication in accordance with an example embodiment;

FIG. 8 is a flow diagram that depicts an example of continuous authentication using two timers in accordance with an example embodiment;

FIG. 9 is a flow diagram that depicts an example of continuous authentication with interdependent timers in accordance with another example embodiment;

FIGS. 10A-C is a call flow that shows an example of continuous authentication in accordance with various embodiments;

FIG. 11 is a block diagram that depicts an example of a multi-device scenario in accordance with an example embodiment;

FIG. 12 is a call flow that depicts multiple devices using the same multi-factor authentication proxy (MFAP) in accordance with an example embodiment;

FIG. 13 is a block diagram of an example dolphin plugin architecture;

FIG. 14 is a block diagram of multiple MFAPs within one device in accordance with an example embodiment;

FIG. 15 is a block diagram showing continuous authentications in a peer-to-peer (P2P) or group scenario in accordance with an example embodiment;

FIG. 16A is a system diagram of an example communications system in which one or more disclosed embodiments may be implemented;

FIG. 16B is a system diagram of an example wireless transmit/receive unit (WTRU) that may be used within the communications system illustrated in FIG. 16A;

FIG. 16C is a system diagram of an example radio access network and an example core network that may be used within the communications system illustrated in FIG. 16A;

FIG. 17 is depicts an example of a security mode control procedure;

FIG. 18A depicts an example network side implementation of using an authentication assertion in accordance with an example embodiment; and

FIG. 18B depicts another example network side implementation of using an authentication assertion in accordance with another example embodiment.

### DETAILED DESCRIPTION OF ILLUSTRATIVE EMBODIMENTS

By way of an example use case, a user wants her personal emails to be automatically updated from a server onto her smartphone on a regular basis. Traditionally, if an email client is present on the smartphone, the emails are regularly updated from the server to the client email application on the phone, and when the user opens the client email application, the user has access to the emails. The phone may have an option to lock the phone when an inactivity period is exceeded. The phone may be unlocked if the user supplies an appropriate PIN/Password. Some users may decide that it is too disruptive to use passwords in order to unlock the phone, and therefore they might not enable any PIN/Password. In such scenarios, anyone who is in possession of the phone is able to obtain the contents of the phone. For example, contents that can be obtained might include emails from the client email application, which can create a serious security condition because many services depend upon a person's access to email to perform sensitive operations (e.g., “password” reset operations). In some cases, users may configure the inactivity lock period to be large (e.g., 30 minutes) before the phone locks. In such scenarios, the security risk is reduced as compared to users who do not lock their phones at all, but there may be a large window (e.g., 30 minute) within which someone may pick up the phone and have access to the contents of the phone. Another example issue associated with locking phones is that in order for the user to unlock the phone she may have to enter her PIN/Password frequently, which may be an irritant that causes the user to shorten the password or to increase the inactivity period to a larger time interval, thereby decreasing the security of the phone and contents associated therewith.

Embodiments described herein use a multitude of authentication factors that are aided by associated authentication functions to perform a continuous authentication, thereby providing a risk-based assurance assessment with reduced friction. Appropriate authentication factors and functions may be invoked on a periodic basis in order to maintain a certain authentication assurance level (AAL), which is referred to herein as an Assurance Threshold (AT). The AAL may decay over time and thus may be refreshed periodically. Embodiments described herein allow a user to experience less friction while leveraging authentications with a higher assurance level. By way of example, a user may wear a biometric sensor (e.g., EKG) device (e.g., a band around the wrist or a pulse rate monitor) that provides biometric readings for authentication. The device may be paired with a smartphone, for example, using Bluetooth. In some cases, the AAL that can be obtained as a result of the biometric authentication (e.g., EKG) may be classified as “Medium” or some quantitative value (e.g., a value 10 on a scale of 1 to 16 where 16 represents a high level of assurance). The AAL may have an associated authentication decay value, which may be based on a time component. In some cases, each application may have its own required assurance level (ALreq). The ALreq may be a quantitative value or a qualitative (e.g., ALreq=Low, Medium, or High). In one example, users can be provided access to applications that require a “Medium” AAL or less, without requiring an authentication in addition to one authentication factor having a “Medium” AAL. The AAL may be recomputed periodically because the current AAL varies, for instance decays, as a function of time. As described below, the AT may take into consideration the decay process associated with each of the authentication functions/factors. The AT may be chosen such that it provides access to commonly used applications, or the AT may be chosen based on the ALreq of a majority of the applications.

In an example, a given ALreq represents the assurance level required by an application for accessing the application. Thus, the Alreq may be the assurance threshold that a user must achieve in order for that individual application to provide access to the user. The AT may be configured by policies and may reflect the AAL that a given system would like to maintain over a certain period. The period may vary based on various variables such as, for example, time of the day (e.g., period is smaller during the day while it is longer during night times). In one example, a difference between the AT and the ALreq is that the AT is a value that is chosen system-wide, which is appropriate for a majority of applications or services or commonly used services (e.g., based on system policies), whereas the ALreq applies to an individual application or is service-specific (e.g., dictated by application policies). In some cases, when the AAL of the user/system falls below the AT because of decay in the freshness of the authentications, then a fresh authentication is performed in order to maintain the AAL above the AT. In certain cases, the AT may vary depending upon policies (e.g., an AT may be reduced during inactive periods such as night times, weekends, etc.), and thus access to certain services or applications may be curtailed, in a seamless manner, when the AT is varied. The continuous authentication functionalities described herein may be managed, orchestrated, and asserted locally, via the network, or via a hybrid-approach.

As described below, in accordance with an example embodiment, authentications are performed in a continuous manner while ensuring that the authentications are minimally invasive and disruptive to the user. At least some of the continuous authentication mechanisms may be carried out periodically to maintain a certain user AAL. During example continuous authentication implementations described herein, active authentications may be carried out using explicit or via implicit means. For example, active data sessions may provide indications related to an AAL. In some cases, re-authentication is performed that intrudes the user and disrupts service minimally. Continuous authentication implementations described herein may utilize behavioral aspects of a user. Example behavioral aspects include a user's commonly used vocabulary or speech patterns when talking or when sending an email/SMS, a user's frequently visited websites, a user's typing speed or pattern, a user's frequent physical location (e.g., city, country, work, home, etc.), or the like. Continuous authentication implementations described herein may utilize biometrics associated with a user. For example, a camera on a device may be used to detect or identify (e.g., via an iris scan) a user. Continuous authentication may also rely on detecting a heartbeat, detecting heat, detecting movement, detecting a person's gait, or the like. Continuous authentication implementations described herein may utilize one or more devices. For example, a second device may be detected by a first device, for example via Bluetooth.

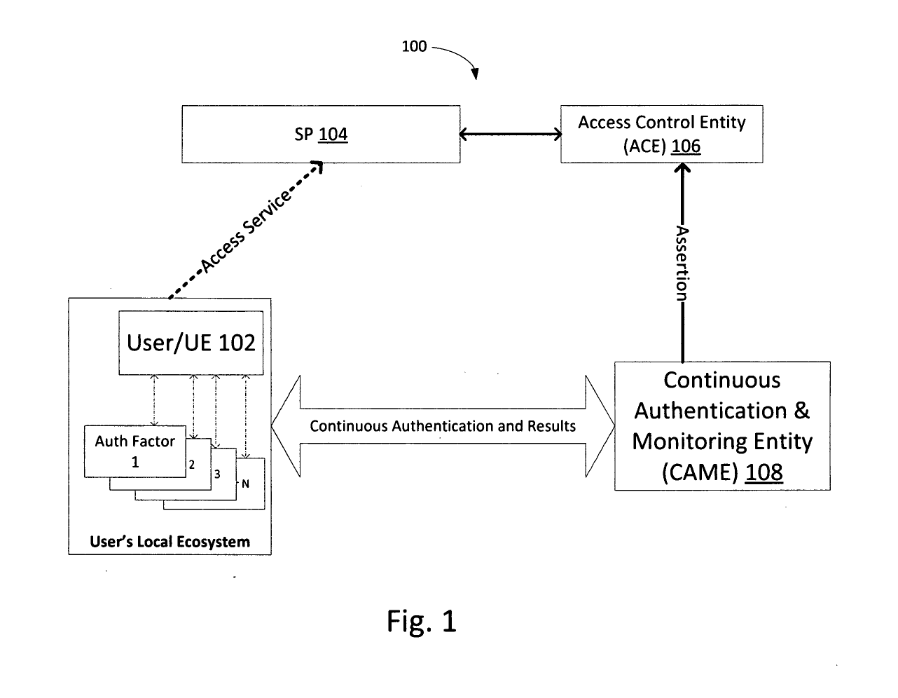

Continuous authentications, which can also be referred to herein without limitation as periodic or active authentications, are authentications that may be carried out on a regular basis with or without the involvement of a user. For example, continuous authentications may be carried out based on a certain time interval. Alternatively, a measure of the Authentication Assurance Level (AAL) may be determined periodically, and then a decision may be made concerning whether further authentications need to be carried out. An example high-level architecture 100 of example continuous authentication functions is illustrated in FIG. 1.

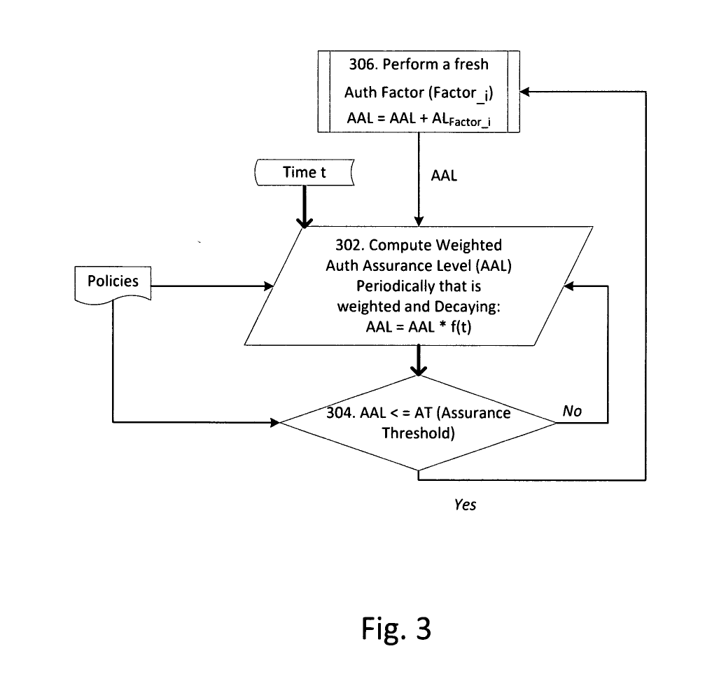

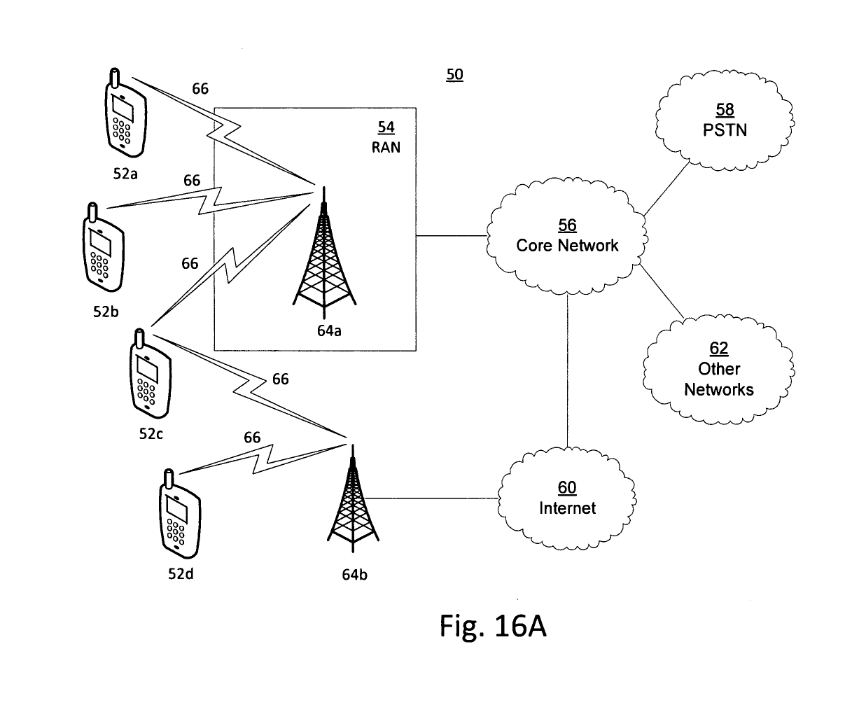

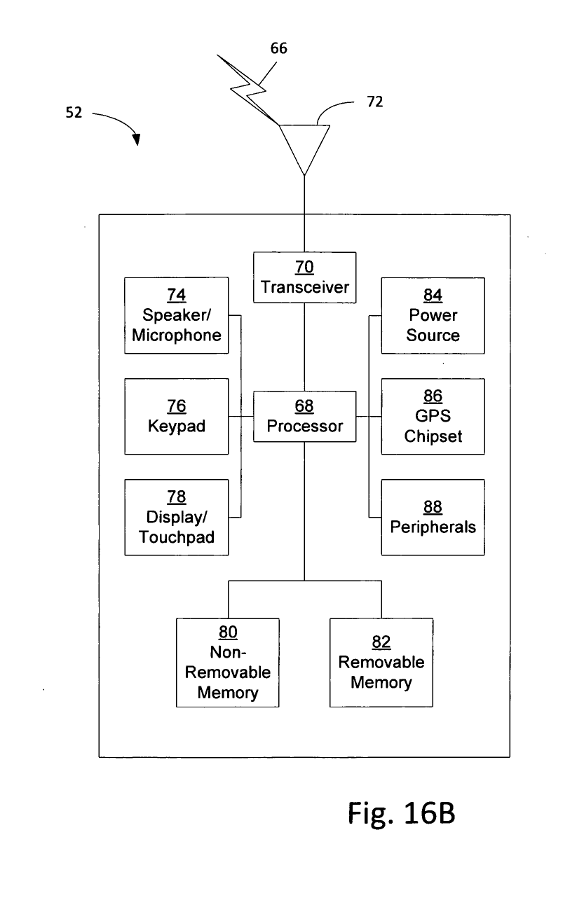

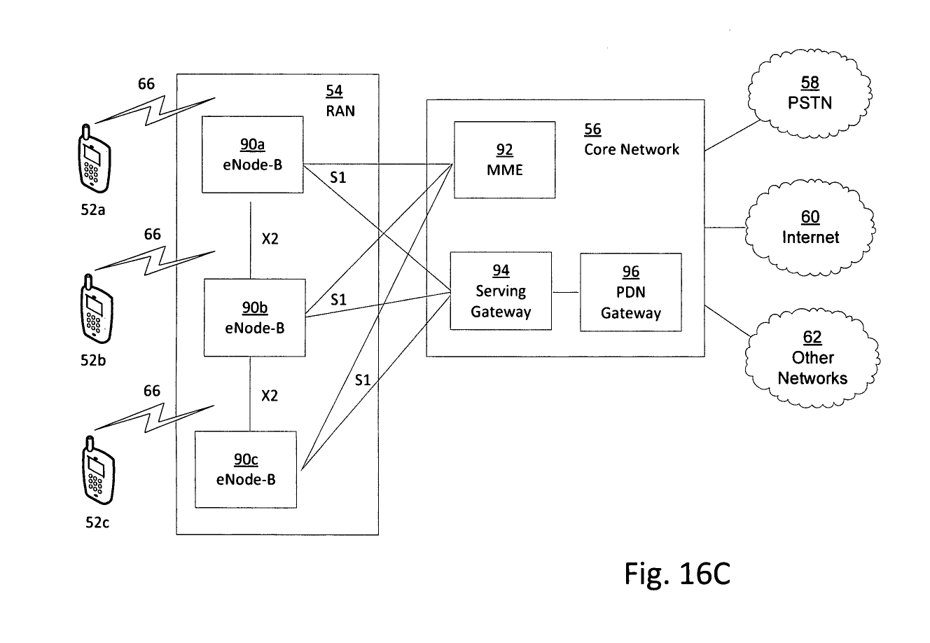

FIGS. 1-15 and 17-18B and the description related thereto illustrate various embodiments of methods and apparatuses for continuous authentication. In these figures, various steps or operations are shown being performed by one or more nodes, devices, functions, or networks. It is understood that the nodes, devices, functions, or networks illustrated in these figures may represent logical entities in a communication network and may be implemented in the form of software (e.g., computer-executable instructions) stored in a memory of, and executing on a processor of, a node of such network, which may comprise one of the general architectures described herein (e.g., see FIGS. 1, 2, 5, 6, 11, 14, and 15). That is, the methods illustrated in FIGS. 3, 7-10C, 12, and 18A-B may be implemented in the form of software (e.g., computer-executable instructions) stored in a memory of a network node, such as for example the node in FIG. 16B, which computer executable instructions, when executed by a processor of the node, perform the steps illustrated in the figures.

Referring to FIG. 1, in accordance with an example embodiment, the example architecture includes a UE 102, a service provider (SP) 104, and access control entity (ACE) 106, and a continuous authentication and monitoring entity (CAME) 108. It will be understood that the SP 104 may be referred to as a relying party (RP) without limitation, and the UE 102 may be referred to as a user, without limitation unless otherwise specified. The user/UE 102 may request services from the SP 104, for example, via a browser or an application. For example, the application may be local application (app) on the UE 102, a web application or an application on a nearby device shared by the UE 102. In response to the request, the user/UE 102 may be required to be authenticated with a certain degree of assurance. In some cases, if the user/UE 102 would like to have continuous access to a given application or services provided by the SP 104, then the user may be continuously authenticated with a certain degree of assurance as required by the given application or service, so that there is no interruption in service. In another example scenario, the user/UE 102 may be authenticated on a continuous basis so that seamless access may be provided to the application or service when the user requests access. Thus, in some cases, delay or latency associated with user authentication is avoided. The CAME 108 may perform the continuous authentication or may enable functions in order to initiate continuous authentication. The CAME 108 may also obtain results (measurements) associated with various authentications that are performed. In addition, certain kernel functions may take advantage of the CAME 108, such that only users who may have been authenticated with a certain level of assurance may be provided with access to perform system-level operations.

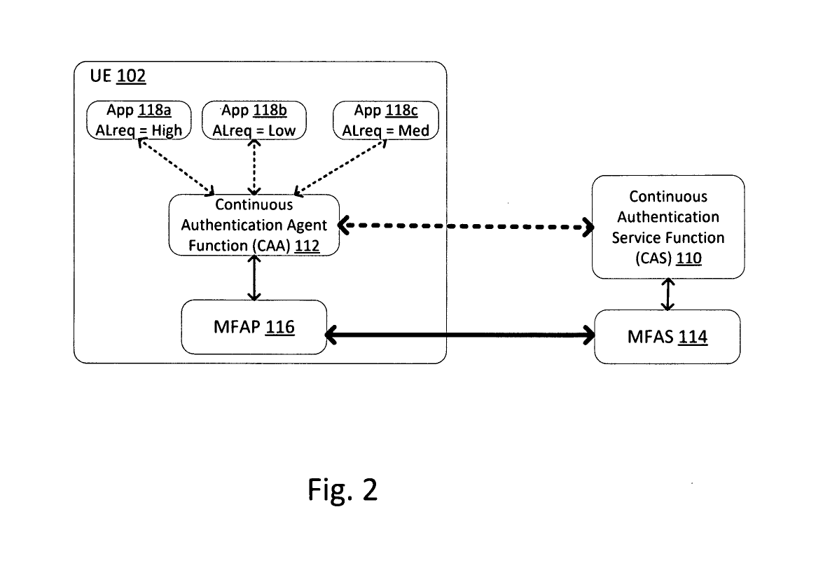

Referring also to FIG. 2, functionality of the CAME 108 may be divided between a server-side Continuous Authentication Server (CAS) 110 and a Continuous Authentication Agent (CAA) 112. As shown in FIG. 2, the CAA 112 may reside on the UE 102. In an example, the CAS 110 may reside in the same server as a Multi-Factor Authentication Server (MFAS) 114. Alternatively, the CAS 110 may be part of the MFAS 114. Alternatively still, the CAS 110 may be a separate entity that interacts with the MFAS 114. The MFAS 114 may use multiple authentication factors from one or more identity providers, which collectively can be referred to as the network side. The MFAS 114 may also use authentication factors from the UE 102, which can be referred to as the client side. With respect to the UE 102, a Continuous Authentication Agent (CAA) may be part of a Multi-Factor Authentication Proxy (MFAP) 116, or may exist as a separate application that communicates securely with the MFAP 116. An MFAP, for instance the MFAP 116, may be a logical entity that coordinates multiple factors of authentication. For example, the MFAP 116 may be accessed using an application programming interface (API), or the MFAP 116 may be implemented as a plugin to a browser. The MFAP 116 may maintain a profile of the UE 102 and the user. The profile may include capabilities, such as authentication capabilities for example, of the user or the UE 102. One or more applications 118, for instance a first application 118a, a second application 118b, and a third application 118c, on the UE 102 may interact with the CAA 112 using an application programming interface (API) or any other mechanism (e.g., Intents) as desired.

In accordance with one embodiment, a given UE, for instance the example UE 102, may be paired with other devices or authentication factor functions that reside on the same device or on other devices. A user of the UE 102 may be associated with multiple authentication factors (1-N). A subset of the factors may be paired with the CAA 112 or the CAS 110 for providing continuous authentication. The authentication factors may cover password authentication (what one knows), device authentication (what one has), biometrics (who one is) and behavioral (how one behaves) factors. In some cases, the process starts by registering the UE 102 into a secure network or system. It will be understood that the UE 102 can be a mobile phone, tablet, or any other portable or static device with input interfaces such as a fingerprint scanner, video camera, touchscreen, etc. The registration of the UE 102 into the secure system may consist of identifying the UE 102 from a list of authorized devices in a database with information about the authentication features each registered device offers. This database might also hold relational information to match security levels with appropriate authentication mechanisms that can grant access at a particular security level.

In some cases, an identified and registered device can then be used as a source of authentications. For example, a registered device can be directly linked to a target device. The target device can be unlocked by using NFC tags, barcode scanning, Bluetooth pairing, Wi-Fi signal strength proximity awareness, geolocation, or any other method indicating that there is a close proximity to the target device. In some cases in which a direct link to the target device is not possible, the user requesting access can directly specify the device to access by manually searching for an identifier of the device or by searching the target device from a list of targets.

Having identified and/or paired the target and authentication devices, in accordance with an example embodiment, the security system consults an internal database to match the required access (or security level) with available authentication mechanisms from the external device. If a match is found and external authentication is accepted by the system, the target device can give an indication to confirm the pairing. Otherwise the process may be finished.

When pairing is confirmed, the external authenticating device may prompt the user, who is requesting access from a service provider, with one or more choices to authenticate by presenting his/her security credentials. The security system may confirm the validity of credentials and may allow for a predetermined number of failed attempts before exiting the system. The maximum number of attempts can be related to behavioral analysis concerning how a user is interacting with the security system. The maximum number of attempts might be determined based other inputs from the authenticating device or any other additional devices (e.g., security cameras). Once a given user is authenticated, the security system may monitor various parameters, such as, for example, usage, time validity of validation, etc. to retain validation or to revoke authentication.

As described herein, selection of a given AT may be based on policies that take into consideration the ALreq of user applications or service provider applications. In some cases, the AT may be based on other factors (e.g., a decay factor of respective authentication factors). An example table for the selection of AT is presented below in Table 1, which shows example applications and their associated assurance level requirements (ALreq).

TABLE 1

| Applications | ALreq | AT selected |
|---|---|---|
| Email App1 | Medium | Medium |
| Email App2 | Medium | |
| Banking App1 | High | |
| Chat App1 | Low | |

FIG. 3 depicts an example of a periodic measurement of an AAL in accordance with an example embodiment. In accordance with an example embodiment, at 302, assurance levels of authentications are periodically measured and weighted accordingly. The measurement of the AAL includes the decay of the assurance level over time. For instance, a first AAL can be computed or measured at 306. A new AAL may be computed using a factor AL (AL_{Factor}_{_}ᵢ) that is obtained as a result of the new authentication. For instance, the new AAL may be computed by adding the factor AL to an old AAL value. At 304, it is determined whether the first AAL that is computed and weighted at 302 is lower than the Assurance Threshold (AT). If the first (current) AAL is lower or equal to the Assurance Threshold (AT), which may be determined by policy, then a fresh authentication may be performed, at 306. If the first AAL is greater than the AT, the process may return to 302, where a new AAL is computed at a later time, based on the period of AAL computation for example, as compared to when the first AAL was computed. The authentication factor to perform the fresh authentication may be determined based on local or network policies and/or applications requesting such continuous authentication services.

The outcome of each authentication factor may be binary, wherein the result is either success or failure, or some soft values, which may be interpreted accordingly based on policies. The resulting assurance level for a given factor is based on the result and a freshness factor which is configurable for each factor.

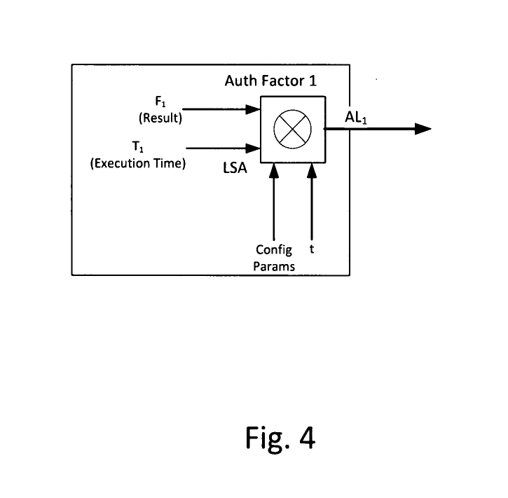

Referring now to FIG. 4, although complex implementations of freshness decay are possible, in a simplified example implementation, the determination of freshness of an authentication factor considers the following input parameters, presented by way of example and without limitation, time of last successful authentication (T1), current time (t), a decay characteristic associated with the application, and a freshness factor. The decay characteristic may be related to the freshness of the authentication which may, for example, be based upon a decay curve, where the freshness of a factor diminishes over time. In an alternate example approach, the freshness may be a step function and considered fresh for a pre-defined period of time after which the authentication is considered stale. Decay may also be specified by an exponential decay factor. The configuration of the freshness decay function may be configured for each authentication factor. In an example, a decay factor is a parameter value representing the rate of decay of the freshness over. A decay type may indicate whether the freshness decays linearly or exponentially. A freshness factor associated with an authentication factor may represent a value in time (e.g., number of minutes) during which a factor is considered fresh after a successful authentication. The factor may be considered “stale” after that period of time elapses. In accordance with an example embodiment, freshness of a given network authentication factor is determined by the MFAS and the freshness of a given local authentication factor is determined by the MFAP in terms of time when an authentication is executed, but the MFAS may configure the specific parameters and computation algorithm related to the local authentication. A local authentication factor refers to an authentication that is performed locally on a device, such as a UE for example. In some cases, the configuration for freshness may be specified as a decaying curve over time with a decay factor, or it may be specified as a step function with a freshness time parameter. The MFAS may configure these parameter values for each network and local authentication factor. The details of decay and freshness time are described further below.

In some cases, if freshness for an authentication factor is configured with a decay factor and type, then the output of authentication, AL, may be determined using an exponential decay or a linear decay. Exponential decay refers to an exponential decay function, where decay is represented by the provided parameter. Linear decay refers to a linear decay of the freshness, from the current level to zero at the time specified by the freshness time.

By way of example, still referring to FIG. 4, if freshness is a step function, then the AL may be determined as follows: 1) if (t−T1)>Freshness Time, then AL₁=0, the authentication should be refreshed; or 2) if (t−T1)<Freshness Time, then AL₁=AL.

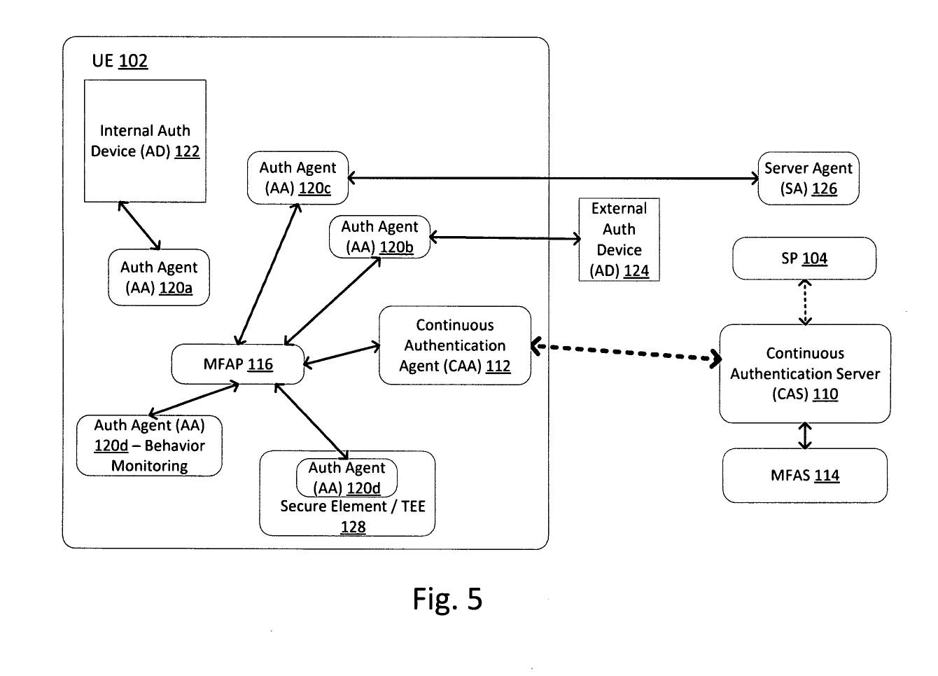

Continuous authentication described herein may be network-based, device-based, or a combination thereof. Referring to FIG. 5, in accordance with an example of network-based continuous authentication (NCA), the Continuous Authentication Server (CAS) 110 resides on a server hosted by an OTT, MNO, Identity Provider, or the like. The CAS 110 is responsible for orchestrating, monitoring, and collecting continuous authentication parameters in order to provide an assurance of a user/device (e.g., UE 102) identity to an application/service. In accordance with the illustrated example, the Continuous Authentication Agent (CAA) 112 resides on the UE 102. The CAA 112 may perform the scheduling, orchestration, and reporting of local authentication functions. Authentications may be performed in an explicit manner or using implicit means.

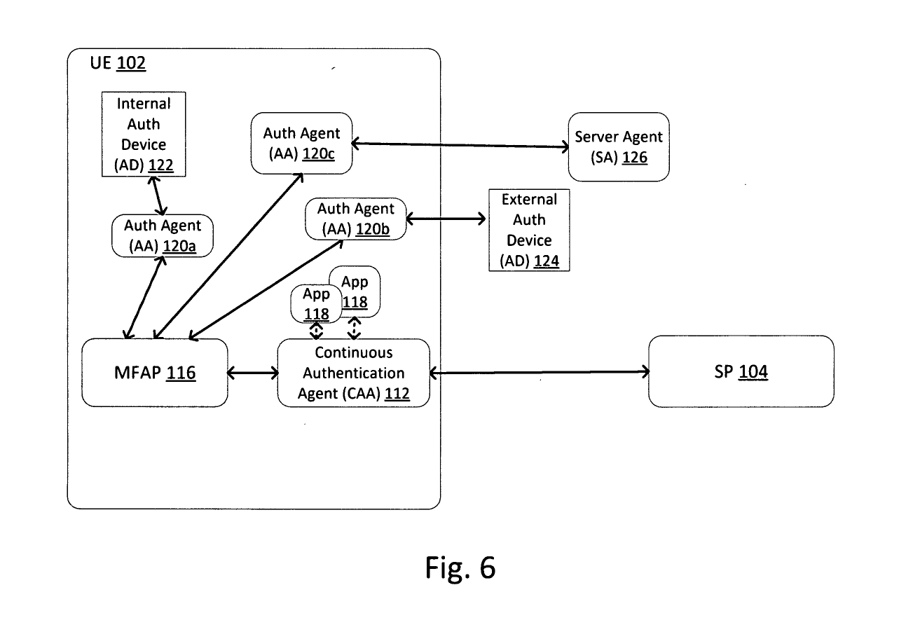

Referring to FIG. 6, in accordance with an example embodiment, in Device-based Continuous Authentication (DCA), a continuation authentication service resides on the UE 102 as the CAA 112. The CAA 112 on the UE 102 manages, orchestrates, and monitors the continuous authentication process. The CAA 112 on the UE is 102 also responsible for providing assurance information directly to applications or services (e.g., applications 118) that reside locally on the UE 102 or on the network.

In some cases, when a given UE is inactive (e.g., when a UE is sleeping) and a CAME is not able to continuously authenticate the user, then the AT might not be achievable, and therefore access to services whose ALreq is higher is restricted and a full authentication process may need to be carried out. A behavioral engine may be part of the CAME, and the behavioral engine may be able to learn the authentication patterns and the AL achieved, for example on a day or time basis. For example, if a particular UE that is expected to be inactive during a certain time of the day is actually active, as indicated by a higher than usual AAL, further authentication using a different factor may be triggered in order to determine the cause for such anomalous behavior.

Some authentications, which may be referred to as implicit authentications, may be carried out so that there is no interruption in user experience. Once a user has been authenticated, certain parameters (e.g., session keys, usage patterns, implicit indications, etc.) may be used for continuous monitoring and authentications. In accordance with an example, embodiment, such an implicit authentication process may use session keys for monitoring a registered user's presence. Once the session keys expire, then a re-authentication may have to be carried out.

Implicit and Continuous Authentications may be carried out using mechanisms such as, for example, Biometric, Behavioral, Possession of Device (based on device usage and connectivity) and what a user knows.

In some cases, when a user is connected to a network (wireless/wired) and authenticated a security association may be established. As a result of the establishment of a security association/context, a Master Session Key (MSK) may be established. Derivative keys for performing integrity protection, message authentication, encryption, key generation, and key encryption may be generated from the MSK.

In some cases, a given UE may use security contexts (e.g., keys) to provide an appropriate type of security functionality required for the type of traffic being sent or received. For example, if the UE is sending a signaling message, then the message may be integrity protected using the appropriate key for deriving a Message Integrity Code (MIC). Similarly, if data traffic is being sent from the UE, then the data may be encrypted using the Ciphering Key (CK).

If a user continues to use a service and if the same key (e.g., MSK) or derivatives thereof are being used by the UE for protecting the traffic that originates from the UE, then the fact that the UE continues to communicate with the same or derivative key may imply, with a high degree of assurance, that it is the same user that setup the connectivity, thereby contributing to the continuous authentication AAL.

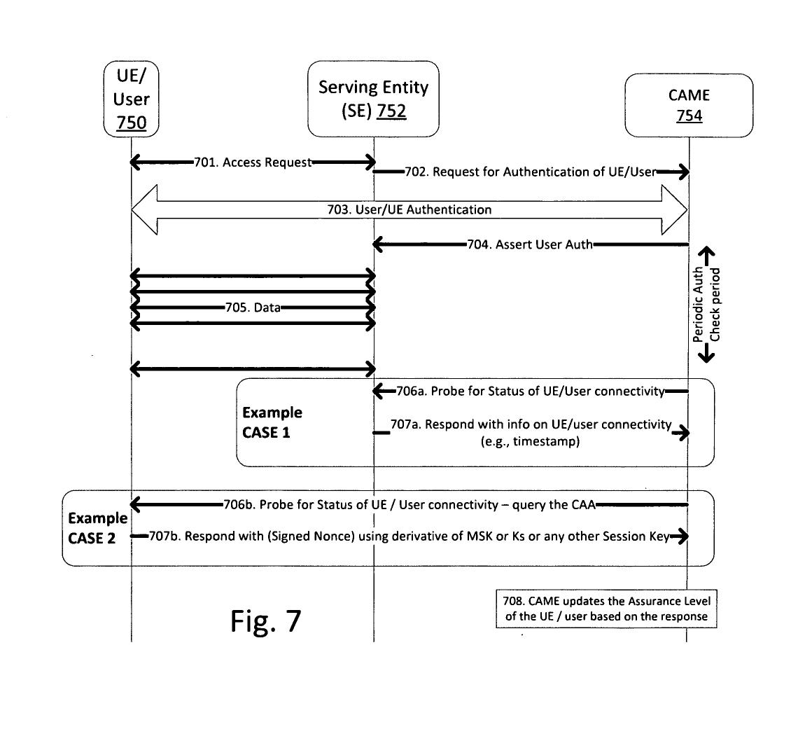

Referring now to FIG. 7, FIG. 7 depicts an example system that includes a UE/user 750, a Service Endpoint 752, and a CAME 754. The SE 752 may be a Wi-Fi Access Point (AP), an LTE eNodeB, or any other network entity as desired. It will be appreciated that the example system illustrated in FIG. 7 is simplified to facilitate description of the disclosed subject matter and is not intended to limit the scope of this disclosure. Other devices, systems, and configurations may be used to implement the embodiments disclosed herein in addition to, or instead of, a system such as the illustrated system, and all such embodiments are contemplated as within the scope of the present disclosure.

In accordance with the illustrated embodiment, at 701, the UE/User 750 requests access to a Service via the SE 752. The SE 752 may host an ACE. The SE 752 may include a Wi-Fi AP, LTE eNodeB, MME, Web Services/Application portals (RP/SP), IPSec Gateway, or any other entity with which the User/UE 750 requests service and may have a security association established therewith. At 702, the UE/User 750 may have an authentication entity associated with the identity that is being used to perform an authentication with the CAME 754. The identity may correspond to the UE or the user of the UE. The Authentication Entity may include a Radius Server, AuC/HSS, or Active Directory/LDAP. Alternatively, the Authentication Entity may be part of the CAME Functionality or provide inputs to the CAME 754. As mentioned above, the CAME 754 may have a local proxy function (the CAA) and a network function (the CSS). The SE 754 may communicate with the CAME 754 in order to authenticate the UE/user 750. At 703, the UE/user 750 is authenticated with the CAME 754. This authentication may which may involve a series of steps, and may be based on one or more protocols (e.g., EAP, TLS, GBA, Kerberos, IPSec, etc.). As a result of the UE/user 750 authentication, a Master Session Key (MSK) may be generated. Depending upon the technology being used, the MSK may be generated based on the standards associated with the SE 752 and the UE/user 750. An example MSK is 256/512 bit key that is cryptographically generated using mechanisms such as the mechanisms described in the EAP-AKA′ protocol. Further derivative keys may be generated from the MSK. At 704, the CAME 754, for example an MFAS that encompasses the CAME 754, may send an assertion vouching for the identity of the UE/User 750. For simplicity, the MFAS and the CAME may be referred to collectively as the CAME/MFAS. The CAME/MFAS may optionally provide a part of the MSK, the MSK, or a derivative of the MSK to the SE 752. The UE 750 may be able to generate the MSK on its own, or it may be provisioned with the MSK or a derivative of the MSK by the CAME 754. The SE 752 and the UE/user 750 may generate derivative keys that may be used for securing the session between the UE/user 750 and the SE 752. Alternatively, the session keys that are generated may not be dependent upon the MSK generated as a result of the authentication process between the UE/user 750 and the CAME 754. The session keys may be generated out of a TLS connection between the UE 750 and the SE 752.

Still referring to FIG. 7, in accordance with the illustrated embodiment, at 705, the data that is exchanged between the UE/user 750 and the SE 752 may be protected (integrity and/or confidentiality for user data and/or message integrity for signaling data) using the session keys that were generated. At 706a, periodically based on the policies at the CAME 754, as shown in example Case 1, the CAME 754 may probe the SE 752 regarding the status of the connectivity of the UE/user 750 to the SE 752. Alternatively, as shown in example Case 2 (at 706b), the CAME 754 may probe the device driver or the application entity that handles connectivity to the SE 752 regarding the status of the connectivity of the UE/user 750 to the SE 752. At 707a in example Case 1, the SE 752 may respond with an assertion that indicates the status of the connectivity, which may be an indication of an active connection between the SE 752 and the UE 750. The assertion at 707a may include a timestamp associated with the last packet received from the UE 750. It will be understood other mechanisms may indicate a current and active connection between the SE 752 and the UE 750, at 707a. Alternatively, as depicted in example Case 2 at 707b, a device driver or connection application (e.g., connection manager) may respond with an assertion that indicates the status of the connectivity. For example, a timestamp associated with the last packet that was sent by the UE 750 may be included in the message at 707b. It will be understood that other mechanisms as desired may indicate a current and active connection between the SE 752 and the UE 750. Thus, an assertion may provide an indication of connectivity for example Case 1 or example Case 2, and the assertion may be cryptographically protected (e.g., confidentiality, integrity, authenticity of message, and/or for replay protection).

At 708, in accordance with the illustrated embodiment, based on examination of the assertion in the response received from the SE 752 or the UE 750, the CAME 754 updates the achieved assurance level of the UE/user 750. The above-described assertion message (at 707a and 707b) may be protected against tampering, replay, and eavesdropping by cryptographical or non-cryptographical means. The assertion may include a nonce, time stamp, sequence counter value, or other token to ensure protection from a replay attack. The assertion may also be cryptographically protected for integrity and/or confidentiality using a derivative of the MSK or Ks (or GBA using Ks_NAF), or using any other key that may facilitate secure communication between the entity in the UE that created the assertion, and the final on UE or off UE entity (e.g., network) that receives the assertion. The assertion may include an assurance level that indicates the quality of the authentication. For example, the assurance level may be based on when the last confirmed authentication was carried out with updates based on, for example, freshness and use of continuous communications based implicit authentication. Example mechanism of generating the assertion are described herein, though it will be understood that other means of processing the assertion locally on the UE or in the network can be performed to facilitate multi-factor authentication as desired. The multi-factor authentication can include a UICC based device authentication with the continued connectivity between the UE and SE as one factor of the multi-factor authentication system. Further, multiple authentication factors may be bound together.

Below is description, by way of example, of authentication methods in an LTE system. It will be understood, however, that the concepts disclosed herein are not limited to LTE, and thus may be applied to any communication system as desired, for example GSM, WCDMA, Wi-Fi, etc.

Now an implicit authentication mechanism based on the LTE authentication process is described in accordance with an example embodiment. Upon the UE initial attachment or re-attachment to the serving network, the UE is being authenticated by its Home Network using the EPS AKA (Authentication and Key Agreement) protocol. In the course of AKA, serving network or SE, acting as Authenticator, uses Security Mode Command (SMC). For two security areas in EPS, NAS and AS, two distinct SMCs are being produced, NAS SMC and AS SMC. Each of them, when issued by the serving network is ciphered and integrity protected by the respective NAS and AS ciphering and integrity protection keys.

When an ME part of the UE can receive SMC, verify integrity of SMC, and read SMC correctly, it means that the UE has been able to positively authenticate the serving network, and that the serving network was able to positively authenticate and authorize the UE for access to the serving network.

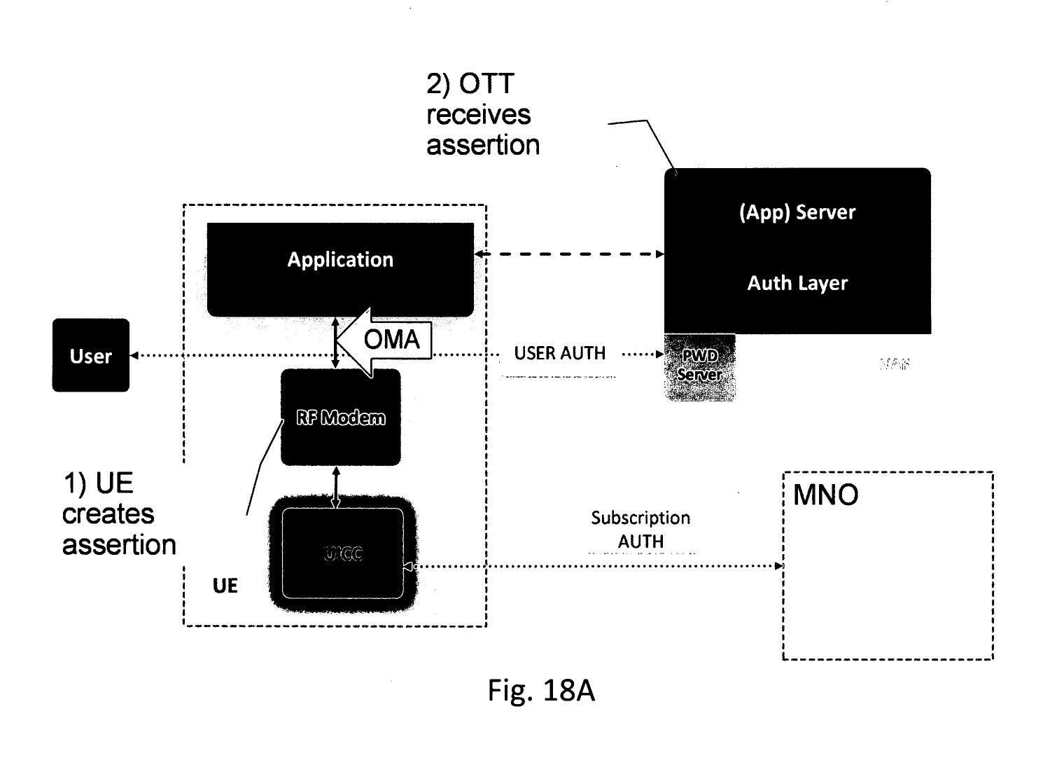

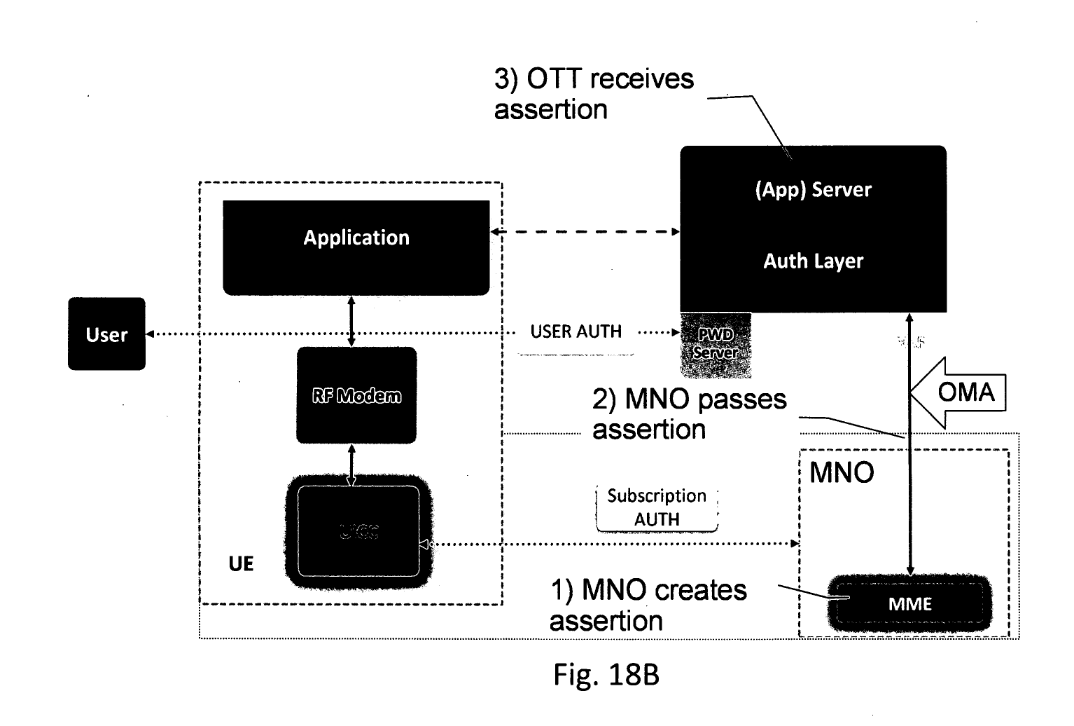

In some cases, with an appropriate API, as illustrated in FIG. 18A, it is possible for an application or the MFAP on a given UE 1802 to initiate RRC messages in/from the UE modem and/or to have visibility of the SMC. Such SMC may be an implicit assertion of Mobile Operator Network (MNO) access authentication, and as such, it can be used by the UE as either single authentication factor or as one of the authentication factors in a multi-factor authentication scheme. Further, such an implicit authentication assertion can also be used for continuous UE authentication.

It is possible to initiate NAS Security Mode Command (NAS SMC) from an ME in Tracking Area Update (TAU) command/procedure. For example, a TAU can be initiated by the UE in some cases per 3GPP TS 24.301, which is incorporated by reference as if the contents of which are set forth herein. Portions of 3GPP TS 24.301 are reproduced below for convenience:
“5.5.3.2.2 Normal and periodic tracking area updating procedure initiation: The UE in state EMM-REGISTERED shall initiate the tracking area updating procedure by sending a TRACKING AREA UPDATE REQUEST message to the MME,
   a) when the UE detects entering a tracking area that is not in the list of tracking areas that the UE previously registered in the MME, unless the UE is configured for “AttachWithIMSI” as specified in 3GPP TS 24.368 or 3GPP TS 31.102 and is entering a tracking area in a new PLMN that is neither the registered PLMN nor in the list of equivalent PLMNs;
   b) when the periodic tracking area updating timer T3412 expires;— UE was in UTRAN PMM_Connected state (e.g. URA_PCH) when it reselects to E UTRAN; . . .
   c) when due to manual CSG selection the UE has selected a CSG cell whose CSG identity and associated PLMN identity are not included in the UE's Allowed CSG list or in the UE's Operator CSG list;”

The abridged list of TAU triggers is reproduced as an example only. The complete list of TAU triggers is specified in TS 24.301. Any of the TAU triggers specified may be used to create an on demand SMC or a new SMC message may be specifically created for the implicit authentication.

The procedure may be initiated by a given UE in ECM-IDLE state or ECM-CONNECTED state. It is ECM-IDLE state that is most appropriate for triggering subscription authentication through the application/modem API; however, whether it is IDLE or CONNECTED can be driven by authentication policy. One of the possible ways to trigger is zeroing the periodic TA update timer through the same API.

As stated above, the SMC is an implicit assertion of MNO access authentication. However, anytime the UE can subsequently verify integrity and decipher network messages (either NAS or AS), such an event indicates that the UE at some point in time successfully performed MNO subscription and access authentication, which resulted in the SMC. This leads to a mechanism for performing continuous authentication, as recognized herein. For example, an acceptable level of continuous authentication strength may be maintained by using two interdependent timers.

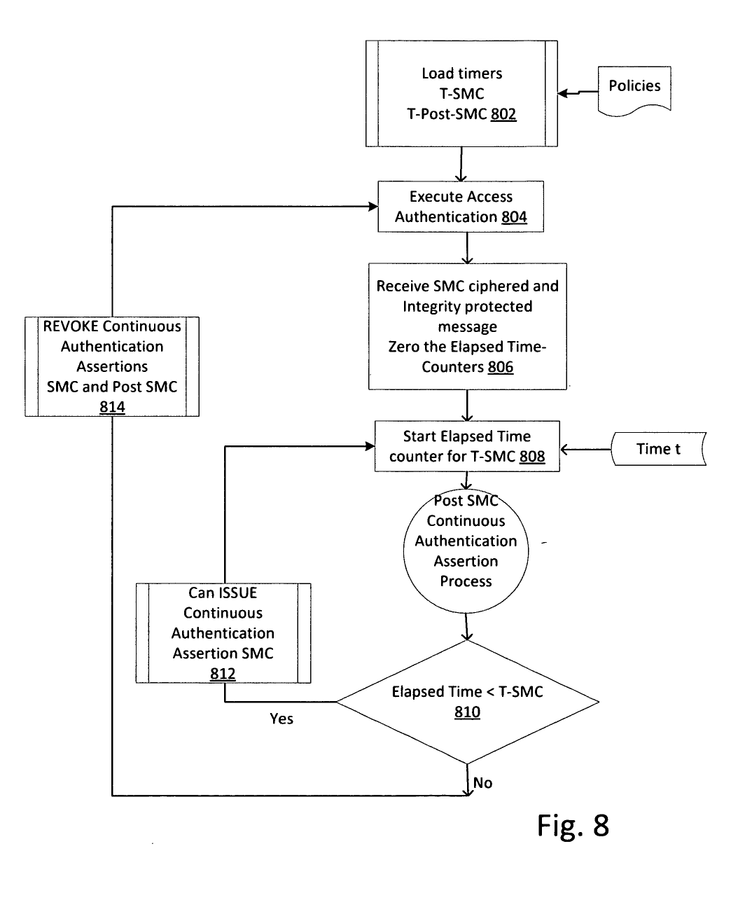

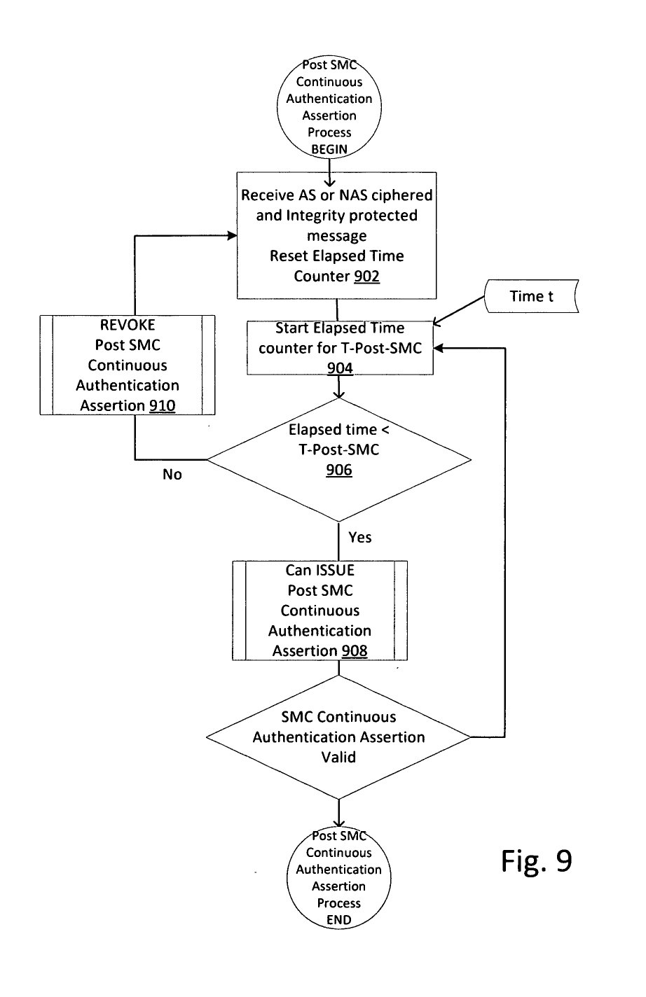

Referring now to FIG. 8, in accordance with the example embodiment, at 802 two interdependent timers, T-SMC and T-Post-SMC, are loaded into a given UE from a Policy server (network or local). An initial Network Access Request is issued from the UE, and access authentication is initiated, at 804. At 806, in accordance with the illustrated embodiment, SMC from the network is received and successfully integrity-verified/deciphered using security associations developed in the course of the AKA run. At 808, the time since the last SMC receipt is counted. At 810, the elapsed time is compared to the value of the T-SMC timer. For example, if the time that has elapsed since the last SMC receipt is less than the value of the T-SMC timer, then, at 812, the assertion of the Continuous Authentication result (which here implies a positive assertion or successful assertion) may be sent to the MFAS/MFAP function, and the procedure continues to the Post-SMC part as illustrated in FIG. 9. Alternatively, if the time that has elapsed since the last SMC receipt is not less than the value of the T-SMC timer, then, at 814, the existing assertions for SMC and Post SMC Authentications are revoked and a new SMC may be requested from the serving network.

Referring to FIG. 9, in some cases, in the Post SMC part of the illustrated procedure, either AS or NAS ciphered and integrity-protected messages/commands are received from the network, successfully integrity-verified/deciphered, and noted (at 902). At 904, in accordance with the illustrated example, the time since the last Post SMC message is counted. At 906, the elapsed time is compared to the value of the Post SMC timer. For example, if the Elapsed Time for the Post SMC message does not exceed the value of the Post SMC timer, then a Post SMC Authentication Assertion may be issued, at 908. Otherwise, in accordance with the illustrated example, the Post SMC Authentication Assertion is revoked (at 910), and a new Post SMC message has to be evaluated.

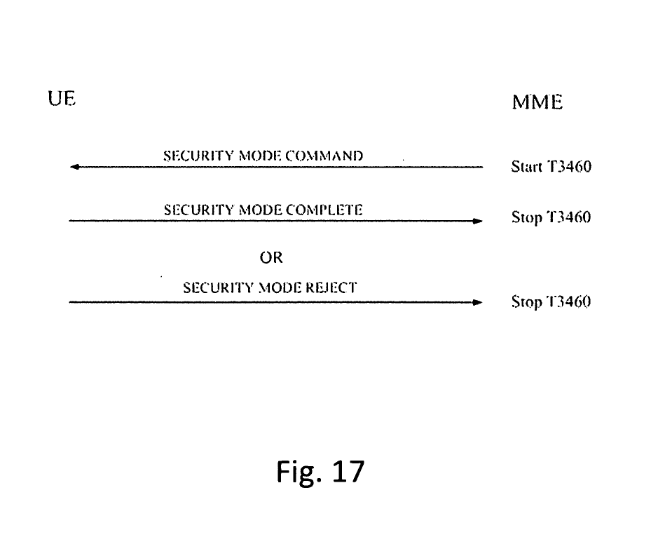

Referring to FIG. 18B, in accordance with an alternative embodiment, an equivalent message to the SMC in the MME in the network fulfills a similar functionality as the SMC. For example, the SECURITY MODE COMPLETE command generated by the UE and sent to the MME provides an indication that the UE successfully received and interpreted the SMC, and that it is able to support the security algorithms supported by the MME and offered in the SMC. For convenience, Clause 5.4.3.3 of TS 24.301 is reproduced below, with reference to FIG. 17:
“Upon receipt of the SECURITY MODE COMMAND message, the UE shall check whether the security mode command can be accepted or not. This is done by performing the integrity check of the message and by checking that the received UE security capabilities and the received nonceUE have not been altered compared to the latest values that the UE sent to the network.”

In summary of the above, the UE can generate an assertion with respect to an access authentication (e.g., AKA) success based on the successful interpretation (e.g., integrity and replay protection) of the SECURITY MODE COMMAND. Clause 5.4.3.2 of TS 24.301 Rel 12 describes the SECURITY MODE COMPLETE message as a response to the SECURITY MODE COMMAND (e.g., SMC). The UE issues a SECURITY MODE COMPLETE message that completes access authentication from the UE point of view, and the receipt of the SECURITY MODE COMPLETE by the MME completes the access authentication from the network point of view. The MME may generate an assertion indicating success in a similar manner to that described for the UE, and relay the assertion to other network entities such as the CAME. Continuous authentication may also be performed by virtue of successfully verifying integrity and deciphering network messages from the UE.

In accordance with an example embodiment, an appropriate API between an application server and the mobile networks enables the application server to initiate an authentication of the UE subscription. As an illustrative example, when the application server wishes to perform an authentication of the UE subscription, it may build an identifier of the Home MNO Network (e.g., URI of HLR, AuC) by analyzing the UE mobile identity (e.g., MSISDN, IMSI, etc.). The UE identity may be registered and known at the application server and bound to the user of the UE. The application server may then query the Home MNO Network using the derived identifier and then receive back the identifier of the Serving MNO Network (e.g., URI of the serving MME). The application server may then contact the Serving MNO Network and request an access layer authentication. An access layer authentication may be derived from an implicit interpretation of the SECURITY MODE COMPLETE message or from successfully verifying integrity and/or deciphering of network messages from the UE on a frequent and/or continuous basis. The Serving MNO Network provides an authentication assertion to the application server after a successful access layer authentication.

The application server may be redirected to either the Home or Visited Serving Network, for example, depending on where the UE is located (e.g., home or roaming scenario). Thus, in some cases, the application server does not need to distinguish between home and roaming use cases.

The authentication assertion may be signed and/or protected by a variety of methods so as to enable verification by the application server. To protect the assertion and communications, a security association may be setup between the UE and the application server, or between the Serving MNO Network and the application server as appropriate. An assertion signing key may be established between the UE and the application server and/or the Serving MNO Network and the application server as appropriate.

Additionally, an authentication transaction ID or context reference may be generated that identifies the authentication that was carried between the UE and Serving MNO Network. In some cases, this transaction ID is known to both the UE and Serving MNO Network, and may be communicated to the application server by either party. The transaction ID may be generated by the UE or Serving MNO Network, and communicated to the other party or mutually generated.

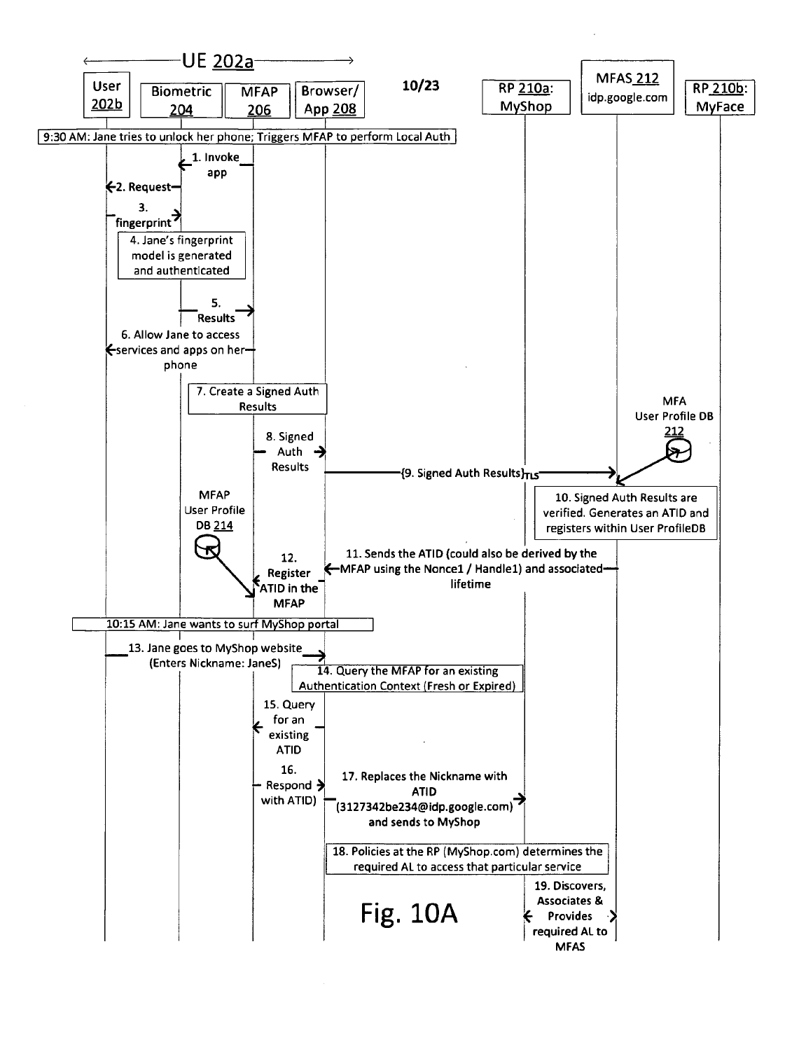

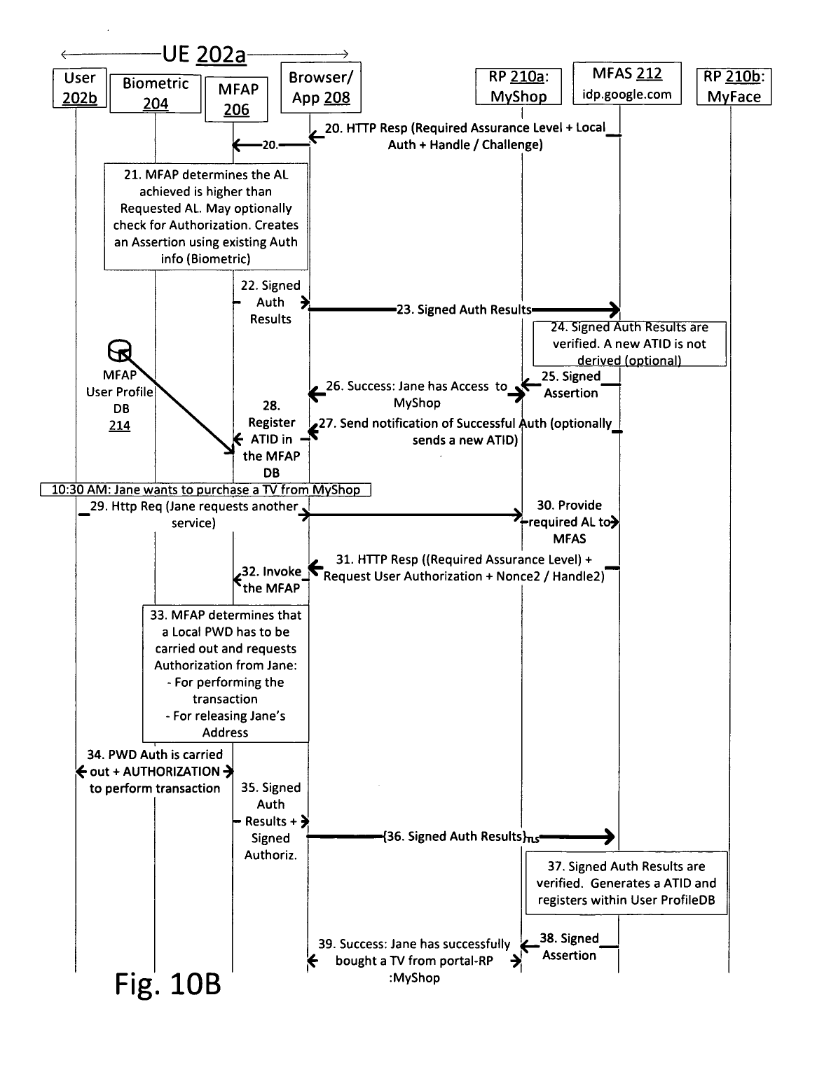

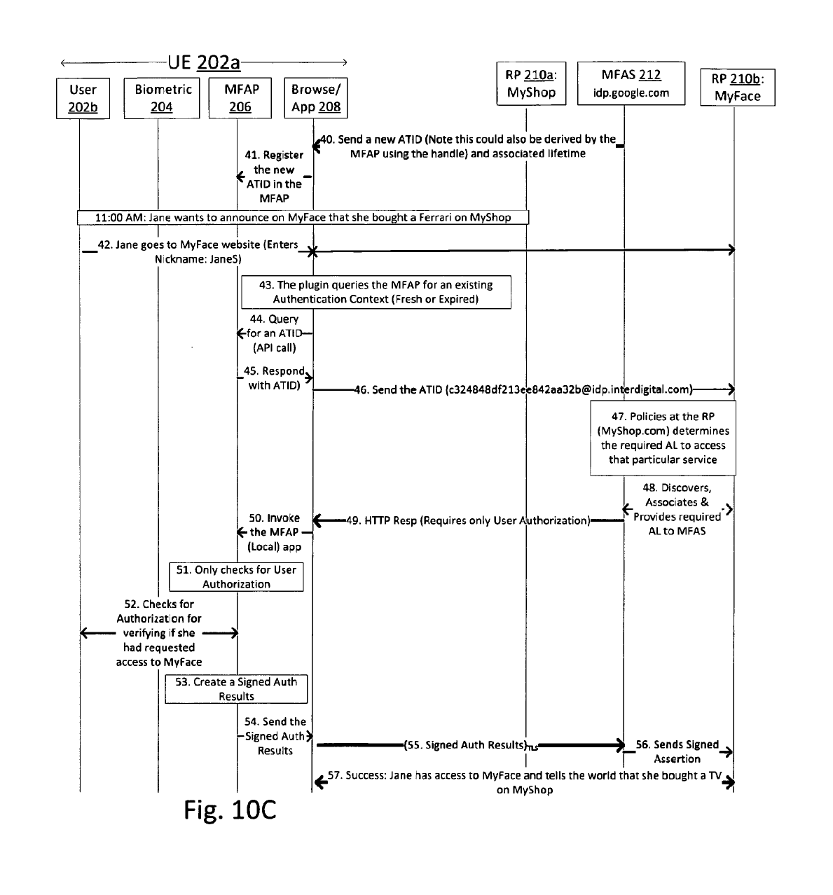

Referring now to FIGS. 10A-C, authentication scenarios are presented in which an End-to-End solution is illustrated and described and various usage scenarios are described. The example system includes a UE 202a having a user 202b. The UE 202a includes a local biometric application 204, an MFAP 206, and a browser or application 208. Unless otherwise specified, browser and application may be used interchangeable herein without limitation, and therefore the browser or application may be referred to as the browser/app 208 for simplicity. The example system further includes a first RP 210a (“MyShop”), a second RP 210b (“MyFace”), and an MFAS 212 (“idp.google.com”). For convenience, the user 202b in the illustrated example is referred to as “Jane”. It will be understood that the names of the user, RP's, and MFAS are presented merely for purposes of example. It will be appreciated that the example system illustrated in FIGS. 10A-C is simplified to facilitate description of the disclosed subject matter and is not intended to limit the scope of this disclosure. Other devices, systems, and configurations may be used to implement the embodiments disclosed herein in addition to, or instead of, a system such as the illustrated system, and all such embodiments are contemplated as within the scope of the present disclosure.

In accordance with the illustrated example, Jane tries to unlock the UE 202a at 9:30 AM. This triggers the UE 202a in order to initiate a local authentication of the user 202b by invoking the services of the MFAP 206. The preferred local authentication factor may be a biometric fingerprint authentication. It is assumed for exemplary purposes that in order for Jane to be able to unlock her phone, the assurance level required by the access control mechanism is “Medium”. Therefore, the assurance level obtained based on the authentication(s) of Jane that are performed must be at least equal or greater than a “Medium” in order for her phone to be unlocked. Thus, for example, if Jane is only authenticated by a password that has an AAL=low, then the password authentication will be insufficient to unlock her phone.

At 1, the MFAP invokes the local biometric app 204. At 2, the biometric app 204 starts the biometric fingerprint authentication process and requests the user 202b (Jane) to swipe her fingers on the biometric sensor present on the UE 202a. At 3, Jane swipes her finger on the sensor, and the generated fingerprints are then provided to the biometric app 204. At 4, the biometric app 204 generates Jane's fingerprint model and then performs an authentication of the generated fingerprint model as compared to the one that was stored in the local secure database during registration. The biometric app 204 then creates an assertion based on the authentication result. At 5, the biometric app 204 sends the assertion to the MFAP 206. At 6, it is assumed in this example that a successful local fingerprint authentication delivers an assurance level of “Medium”, and therefore an access control entity (ACE) provides Jane with access to her phone features based on the assurance level requirement. At 7, the MFAP 206 generates a signed assertion. The signed assertion may indicate the AAL achieved (e.g., Medium), and may also contain specific details indicative of, for example, the authentication process, accuracy of the fingerprint matching, fingerprint sensing matching software, fingerprint reader information, or the like. This information may be signed by the MFAP 206 using public keying mechanisms or by using a symmetric key shared between the MFAP 206 and the MFAS 212. At 8, the signed assertion may be sent via the browser 208 or via a secure connection (e.g., TLS, EAP etc.). At 9, the browser 208 sends the signed assertion to the MFAS 212 via a HTTPS connection, or it is communicated directly by the MFAP 206 to the MFAS 212 in a secure manner (e.g., by means of a TLS connection).

Still referring to FIG. 10A, in accordance with the illustrated example, at 10, the MFAS 212 verifies the signed assertion. An Authentication Transaction ID (ATID) is generated by the MFAS 212. The MFAS 212 registers the ATID along with the results in a user database (DB) 212. A timestamp and assurance level obtained from the MFAP 206 may also be registered within the database 212. The ATID may be generated using cryptographic means or may be a random value. The ATID may take the form: ATID-prefix=PRF (IDGK, Nonce∥“ATID_Generation_Process”∥MFAPID∥MFASID) Where: IDGK=ID Generation Key, which may be a derivative of the Long-term-secret that is associated between the MFAP and the MFAS. The Nonce is randomly generated; Nonce may contain some session information and therefore may also be referred to as the “association handle”. The Nonce, the string “ATID_Generation_Process” as well as the identity of the MFAP 206 (referred to as an MFAPID) and the identity of the MFAS 212 (referred to as MFAPID) are all concatenated and used as the input in order to generate the ATID-prefix. The ATID is computed by appending the ATID prefix with the FQDN of the MFAS 212, the IdP, or MNO and represented as: ATID=ATID-prefix@mfas.com or ATID-prefix@google.com (name belongs to the IdP domain). Other mechanisms to generate the ATID may be employed as long as the generation mechanism results in a unique identity within the realm of the IdP, MFAS, MNO or the any identity provider. At 11, the MFAS 212 sends an acknowledgement and requests the MFAP 206 to register the ATID, which is sent by the MFAS 212 to the MFAP 206. Alternatively, the MFAS 212 may just send the Nonce/Association Handle. The MFAP 206 may be able to generate the ATID on its own using the Nonce/Association Handle provided to it by the MFAS 212 with the IDGK. The MFAP 206 and MFAS 212 may be able to generate the IDGK on their own using the master secret shared by both the MFAS and MFAP. The ATID has an associated time validity. At 12, the browser 208 may optionally forward the message to the MFAP 206. In accordance with the illustrated example, the MFAP registers the ATID on a local user database 214, along with the time validity.

Still referring to FIGS. 10A-C, in accordance with the illustrated example, at 13, Jane (at 10:15 am) wants to purchase an item from the MyShop portal. Jane may enter her nickname instead of her full name. At 14, the browser plugin queries the MFAP 206 for an existing authentication context (which can also be referred to as the ATID). In an example in which a mobile app is associated with the RP 210a: MyShop, MyShop may query the MFAP 206 for a fresh or existing ATID. At 15, the browser/app 208 sends a query for a fresh and valid ATID to the MFAP 206. At 16, the MFAP 206 responds with the latest ATID, which may be valid or expired. In an example, the last registered ATID is sent as a response to the browser/app 208. At 17, the browser/app 208 replaces Jane's nickname with the ATID and forwards the message via the browser/app 208 to the RP web portal: MyShop. At 18, policies at the portal (RP 210a: MyShop) may determine the appropriate assurance level based on the transaction requested by Jane. At 19, the RP 210a: MyShop performs an OpenID Discovery and Association with the IdP that is associated with the ATID. Because the ATID is of the form of a network access identifier (xyz@mfas.com/xyz@gogle.com), the RP 210a may be able to discover it. The RP 210a conveys the Assurance Level required by the RP 210a so that Jane is provided with access to the services on MyShop. At 20, based on the assurance level requested and the existing (active) AL achieved by Jane, the MFAS 212 may request further authentication or may send an assertion to the RP 210 without requiring any further authentication. If further authentications are required, the MFAS 212 may send an intent requesting the MFAP 206 to perform one or more appropriate local authentications, based on the AL requested. An Association Handle/Nonce may also be optionally provided.

At 21, in accordance with the illustrated example, the MFAP 206 determines that no further authentications are to be carried out if the achieved AL is greater or equal to the requested AL. The MFAP 206 may perform an authorization check with Jane to see if she had indeed authorized to perform the operations on the MyShop portal using a client notification (e.g., by means of SMS, pop-up, etc.). The MFAP 206 may create a new assertion using information from fresh (previously conducted) authentication results along with optional authorization information. At 22, the MFAP 206 forwards the signed authentication (Auth) results via the browser 208 (in some cases, this is optional only if the browser 208 is used as an intermediary). At 23, the browser/app 208 forwards the signed auth results via a HTTPS connection (in some cases, this is optional only if the browser 208 is used as an intermediary), or the results may be sent directly by the MFAP 206 to the MFAS 212 using a TLS connection. At 24, in accordance with the illustrated example, the MFAS 212 verifies the Auth results. Because no new authentications were carried out, a new ATID might not be derived. This (whether to derive a new ATID) may be left to implementations as desired. At 25, the MFAS 212 sends a signed assertion to the RP 210a: MyShop. At 26, the RP 210, upon verifying the signed assertion from the MFAS 212, provides Jane with access to the RP 210a: MyShop. At 27, the MFAS 212 may optionally send a notification to the MFAP 206 along with a new ATID (optional) that signifies a successful authentication. At 28, in accordance with the illustrated example, if a new ATID was generated, then the MFAP 206 registers that in the MFAP user database 214.

Still referring to FIGS. 10A-C, referring in particular to 29, at 10:30 AM, Jane wants to purchase a television from RP 210a:MyShop. Jane, via the browser 208, initiates the transaction to purchase on the web portal: MyShop. Based on a risk-based transaction analysis, the RP 210a requests that Jane is authenticated using a higher assurance level. The RP 210a may convey a new AL to the MFAS 212.

At 30, based on the new AL requested by the RP 210a, and taking into consideration the existing fresh authentications, the MFAS 212 may request further authentications of Jane. The MFAS 212 sends the request to the MFAP 206 along with an optional request for Jane's authorization and a Nonce/Handle (optional). At 31, the browser/app 208 forwards the request to the MFAP 206 (optional). This may be send by the MFAS 212 directly to the MFAP 206. At 32, the MFAP 206 is invoked by the browser/app 208. At 33, based on the AL requested by the RP 210a and the current AL achieved by Jane, the MFAP 206 determines that a password-based authentication may have to be additionally carried out. Also optionally, the MFAP 206 may request that Jane authorize the transaction. The authorization that might be required in order to perform the transaction may be carried out using another channel (e.g., SMS/text or other means). Further, the MFAP 206 may also optionally request authorization for releasing Jane's address. At 34, in accordance with the illustrated example, password authentication is carried out locally and authorizations are obtained from Jane. At 35, the MFAP 206 creates a signed assertion of the authentication results and authorization information, and sends the assertion, via the browser 208 (optionally may be sent directly from the MFAP 206 to the MFAS 212 using TLS connection). At 36, signed results are sent to the MFAS 212 using an HTTPS connection. In some cases, this may be sent directly from the MFAP 206 using a TLS connection.

At 37, the MFAS 212 verifies the signed auth results and generates a new ATID using new Nonce2/Association Handle2. The MFAS 212 registers the ATID along with the auth results, timestamps, and the AL achieved in the user profile DB 212. At 38, the MFAS 212 sends the assertion to RP 210a: MyShop. At 39, Jane is authenticated and provided with access to MyShop and Jane completes the transaction on the RP 210a: MyShop and successfully buys the television. At 40, the MFAS 212 sends the ATID so that it can be registered with the MFAP 206. Optionally, the MFAS 212 instructs the MFAP 206 to derive the ATID on its own using the Nonce 2/Handle 2, and other keying material that is available with the MFAP 206. At 41, the MFAP 206 registers the ATID within the user profile DB 214 on the MFAP 206. Referring to 42, at 11:00 AM, Jane wants to announce on another portal, RP 210b: MyFace, that she had just bought a TV on MyShop at a bargain price. Jane enters her nickname on the MyFace website. At 43, the browser/app 208 queries the MFAP for an existing ATID. At 44, the browser/app 208 sends the query to the MFAP 206. At 45, the MFAP 206 responds with the latest ATID, which may be expired or fresh. At 46, the browser/app 208 replaces the nickname with the ATID (e.g., c324848df213ee842aa32b@idp.interdigital.com) and forwards the message to the RP 210b: MyFace. At 47, in accordance with the illustrated example, the RP 210b: MyFace determines the required AL based on risk-based access for that service. At 48, in accordance with the illustrated example, MyFace performs Discovery and Association based on the ATID information that was provided, which contains Jane's IdP information, and provides the MFAS 212 with the AL that is required.

At 49, in accordance with the illustrated example, the MFAS 212 determines that the AL required is less than or equal to the AL that has been freshly achieved so far, and therefore only requests Jane's authorization. The MFAS 212 sends the request to the MFAP 206 via the browser 208 or using direct secure connection (e.g., TLS), which may be sent directly by the MFAS 212 to the MFAP 206. At 50, the browser/app 208 invokes the MFAP 206. At 51, the MFAP 206 determines that only a user authorization is required. At 52, the MFAP 206 may send an authorization request to Jane using another channel (e.g., via another device, SMS, other wearable device). Jane provides her authorization. At 53, the MFAP 206 creates a signed assertion using the authorization as part of the message. At 54, the MFAP 206 sends the signed assertion to the MFAS 212 via the browser 208 (may be sent directly). At 55, the signed results are forwarded by the browser/app 208 to the MFAS 212 using a secure protocol (e.g., TLS, HTTPS.). At 56, after verifying the assertion provided by the MFAP 206, the MFAS 212 creates a signed assertion and forwards it to the RP 210b: MyFace. The MFAS 212 registers the authorization information in the user profile DB 212. At 57, the RP 210b: MyFace authenticates Jane, determines that Jane has been successfully authenticated to MyFace, and informs connected users that Jane bought a TV on MyShop.

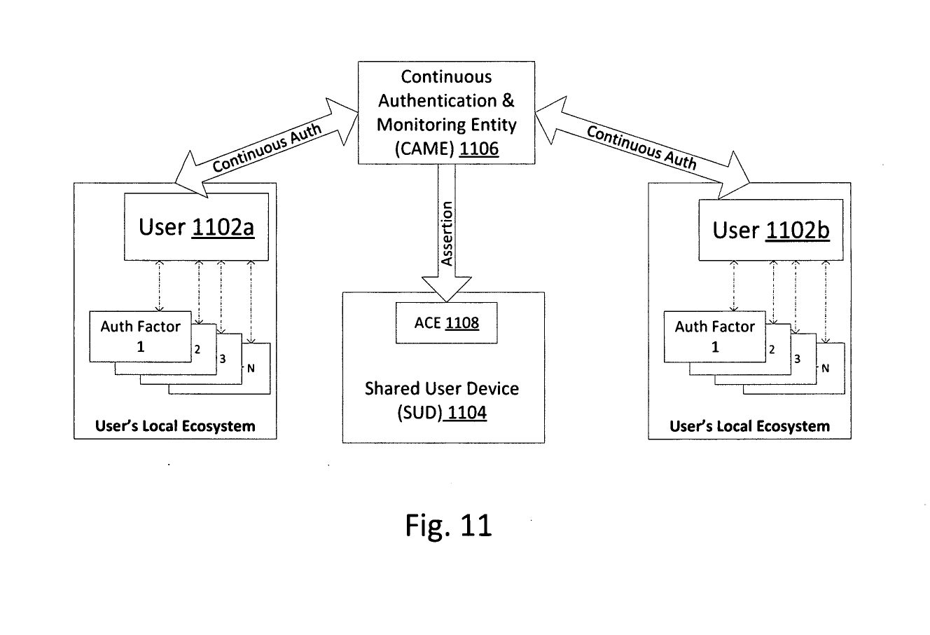

Referring now to FIG. 11, a plurality of users, for instance a first user 1102a and a second user 1102b, may want to use a shared device, for instance a shared user device (SUD) 1104. Example shared user devices include, without limitation, a printer, scanner, desktop machine, and tablet. The users 1102a may use the shared user device 1104 at a home or enterprise. Referring to FIG. 11, the first and second users 1102a and 1102b are continuously authenticated by a CAME 1106, which may reside in another device or in one of the user devices 1102a and 1102b. When one of the users 1102a and 1102b wants to access the SUD 1104, the user may be seamlessly authenticated with an access control entity (ACE) 1108 on the SUD 1104, based on an assertion from the CAME 1106. The ACE 1108 may restrict the user's access to the applications and operations/file-systems. For example, each of the users 1102a and 1102b may be provided with a personalized container on the SUD 1104, which provides distinct security partitions between each user's respective containers.

A user that uses multiple devices may wish to isolate the “freshness” of successfully authenticated factors in one device from those in another device. Without isolation, an attacker, with the knowledge that the user has just performed authentication with a fresh password factor, may log-in to a RP via a browser without the OP prompting the user to provide a password. Furthermore, without “freshness” isolation between devices, “assurance level creep” may occur in a scenario in which a factor with a low assurance level is considered fresh for the same factor in another device, but is designated with a higher assurance level.

In MFAS, its database has policy/log entries for each device registered under a user. Based on the capabilities of a device, it may have a set of factors for authentication, different from the set in another device. The set may change based on the RP identity according to the service level agreement with the RP. The same factor in different devices may provide different assurance levels. e.g. the finger print factor on an Apple device may provide more assurance than the same factor in another device by a different manufacturer

Each MFAP corresponding to a user/device has a MFAP id. To enforce the freshness isolation, the timestamp and retry count of the same authentication factor is kept separately for each MFAP id. Each MFAP has its own Long-Term-Secret and an ATID is associated with an MFAP id and is a temporary identifier of MFAP id. If the ATID is only used between MFAS and MFAP in a secure channel, the ATID can also be used as a token representing a still valid authentication.

A “default device” is a device that is not registered by the user, such as a browser on a desktop computer for example. The authentication factor for a default device may be generic, such as password for example. A default device does not provide MFAS with a MFAP ID or ATID. This triggers the MFAS to use the one or more factors configured for the default device to authenticate the user. The MFAS may choose not to store the timestamp of default device authentication, i.e. disregarding the freshness of the authentication, because it may not be able to distinguish whether two authentication attempts are from the same “default device”. Alternatively, the http session cookie (transported in a secure channel) with appropriate session timeout, can be used to determine the “freshness” of the prior authentication via the default device.

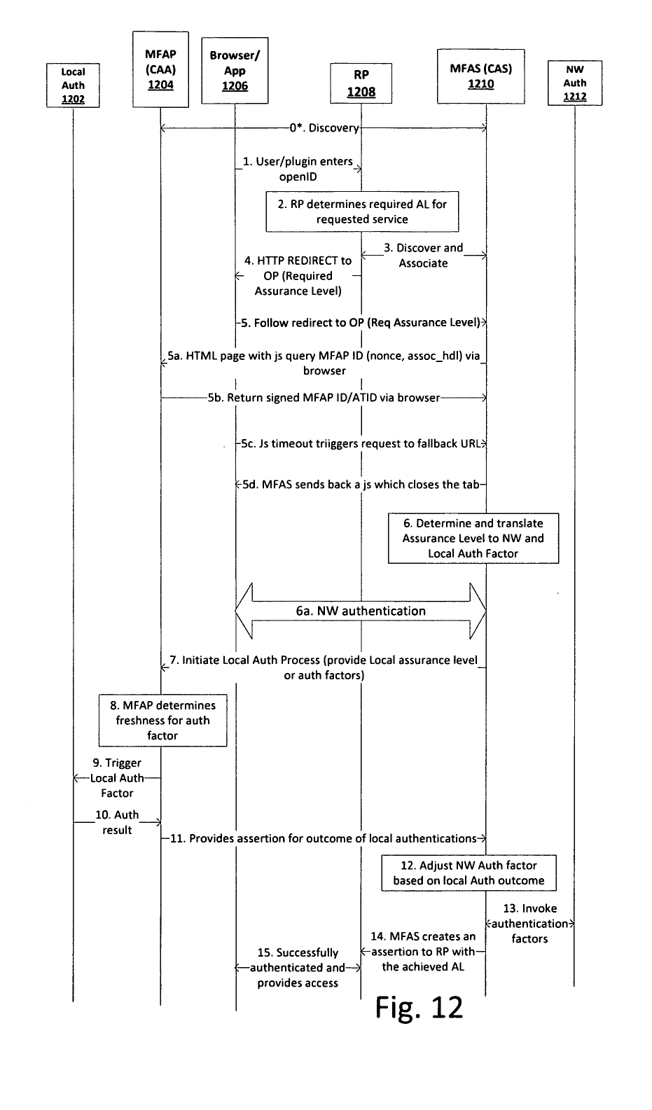

In some cases, because of the isolation of “freshness” among devices of the same user, and because the set of configured authentication factors can be different for different devices, MFAP ID/ATID (or the lack of device IDs) are conveyed to the MFAS during the authentication, in accordance with an example embodiment. Referring to FIG. 12, the following disclosure describes different embodiments of device ID signaling.

FIG. 12 depicts an example system that includes one or more local authentication agents 1202, and a UE that includes an MFAP 1204 and a browser or application 1206 (which for convenience can be referred to as a browser/app 1206). Unless otherwise specified, the terms browser and application are used interchangeably without limitation. The illustrated system further includes an RP 1208, an MFAS 1210, and one or more network authentication agents 1212. It will be appreciated that the example system illustrated in FIG. 12 is simplified to facilitate description of the disclosed subject matter and is not intended to limit the scope of this disclosure. Other devices, systems, and configurations may be used to implement the embodiments disclosed herein in addition to, or instead of, a system such as the illustrated system, and all such embodiments are contemplated as within the scope of the present disclosure.

In accordance with the illustrated embodiment, at 0, the MFAP 1204, in particular a CAA of the MFAP 1204, and the MFAS 1210, in particular a CAS of the MFAS 1210, discover each other. At 1, the user/UE, via the browser/app 1206, provides a user ID to the RP 1208. At 2, the RP 1208 determines a required AL that corresponds to the service that the user requested. At 3, the RP 1208 and the MFAS 1210 discover each other and associated with each other. At 4, the RP 1208 sends an HTTP redirect message to the UE, via the browser/app 1206. The redirect message may include the required assurance level. At 5, the authentication request is redirected to the MFAS 1210. At step 5a, the MFAS 120 sends, to the browser 1206, an html page, which may contain a javascript procedure to trigger a custom soid.scheme URL or trigger the MFAP 1204. In accordance with the illustrated example, the query string of the custom URL indicates the MFAP ID query, a nonce, and an association handle. If the custom URL is supported, the MFAP 1204 pops up a timer that brings the browser 1206 to a fallback URL at timeout. At step 5b, if 5a succeeds, the MFAP 1204 returns its MFAP ID or ATID from a previous authentication instead of its own http(s) agent. The MFAP ID or ATID is signed by PSK (which can be reconfigured every few months). The message at 5b also may include the nonce and the association handle. The message at 5b is sent via the browser/app 1206. In accordance with the illustrated example, when the MFAS 1210 receives the MFAP ID/ATID, it adds the received ID to a session attribute. At 5c, the timer that started at step 5a times out, and the browser 1206 may send an http request to a fallback URL. If MFAS ID/ATID is in the session attribute (e.g., step 5a was successful) the MFAS 1210 may continue with step 5d. If MFAS ID/ATID is not in the session attribute (e.g., 5a was not successful), the MFAS may skip illustrated step 5d and continue with step 6. For example, at 6a, the MFAS 1210 may return an authentication page based on a “default device.” At step 5d, in accordance with the illustrated example, the MFAS 1210 sends back an HTML page with javascript to close the browser tab.

Still referring to FIG. 12, in accordance with the illustrated example, at 6, the MFAS 1210, based on the required AL, determines the combination of local and network (NW) based authentication factors (as detailed above). At 7, the MFAS 1210 initiates the local authentication process, by sending a message to the MFAP 1204. The message may contain the required AL and/or authentication factors that are required to achieve the AL. At 8, the MFAP 1204 determines the freshness levels of the various authentication factors. The MFAP 1204 may further determine the required authentications that may have to be carried out. At 9, in accordance with the illustrated embodiment, the MFAP 1204 triggers one or more appropriate local authentication factors. At 10, the results of the authentication factors are provided to the MFAP 1204 by one or more local authentication agents 1202. At 11, the MFAP 1204 creates an assertion that contains the outcome of the various authentication factors. The assertion may also indicate the achieved assurance level. At 12, in accordance with the illustrated example, based on the results of the local authentications that were carried out, the MFAS 1210 determines the appropriate network-based authentication factors that may have to be carried out. At 13, the MFAS 1210 initiates the various network-based authentications by invoking one or more network authentication agents 1212, and obtains the results of the network authentications that are carried out. At 14, the MFAS 1210 creates a signed assertion to the RP 1208 and provides the achieved AL. The RP 1208 may verify the assertion, and provides the user with access to the RP's services in accordance with the assertion.

Referring still to FIG. 12, step 5c is performed at least because there is currently no browser-independent way to detect whether a custom URL is supported by the UE. The resulting mechanism is that the timer runs on the UE, while the logic for determining whether the UE (which supports the MFAP 1204) is running on the MFAS 1210 is based on whether the MFAS ID/ATID was returned.

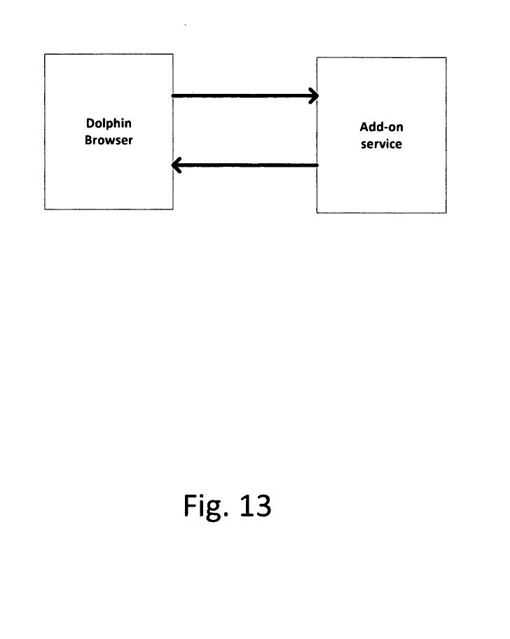

In an alternative embodiment, step 1 of FIG. 12 is mobile browser dependent, and uses a dolphin plugin architecture shown in FIG. 13. This approach corresponds to the call flows shown above. The add-on service class may be integrated as part of the MFAP application (e.g., the same process as the MFAP), such that the add-on service can access MFAP internal class variables.

With continuing reference to FIG. 12, at step 1, in accordance with an example embodiment, the user/UE requests to sign on to a service provided by the RP 1208, using an OpenID identity for logging in to the RP 1208. A browser plugin converts the user entered OpenID to a custom OpenID, which incorporates the user ID and the MFAP ID. Alternatively, if the plugin has the information that the MFAP/user has already been authenticated, the custom OpenID conveys an authentication ID (ATID), which can be associated with an existing logged-in user/device combination at the MFAS 1210.

Continuing with the example above, in some cases, the legacy RP may see the same user (with different devices) as different users, because different OpenIDs were presented at the time of login. To address this issue, the MFAS 1210 may use part of the OpenID Connect procedure to return an ID Token with the authentication response message. The RP 1208 can be enhanced to use an ID token to query the actual user identity with the MFAS 1210.

The MFAP/Addon may need to be configured with the textfield name/id of the RP login page. In some cases, if there is a redesign of the RP login page, the MFAP/addon database is changed accordingly.

In some cases, with respect to the desktop browser or mobile browsers other than dolphin, the plugin is not present. In an example, the user may log in using its original OpenID, and the “default device” policy applies.

In yet another alternative embodiment, the dolphin plugin alters the http request in step 5 instead of step 1. Unlike the above-described embodiment, the Legacy RP sees the user (with different devices) as the same user. The OpenID redirect is detected by addon using the well-known openid.x fields. The MAP/addon is agnostic to RP login page redesign. The plugin does not change openid identifier itself but changes the authentication request message to convey the MFAP id/ATID instead. For example, the ATID can be used as a secret token associated with a not-expired authentication, if it is transported in a secure channel between the browser 1206 and the MFAS 1210.

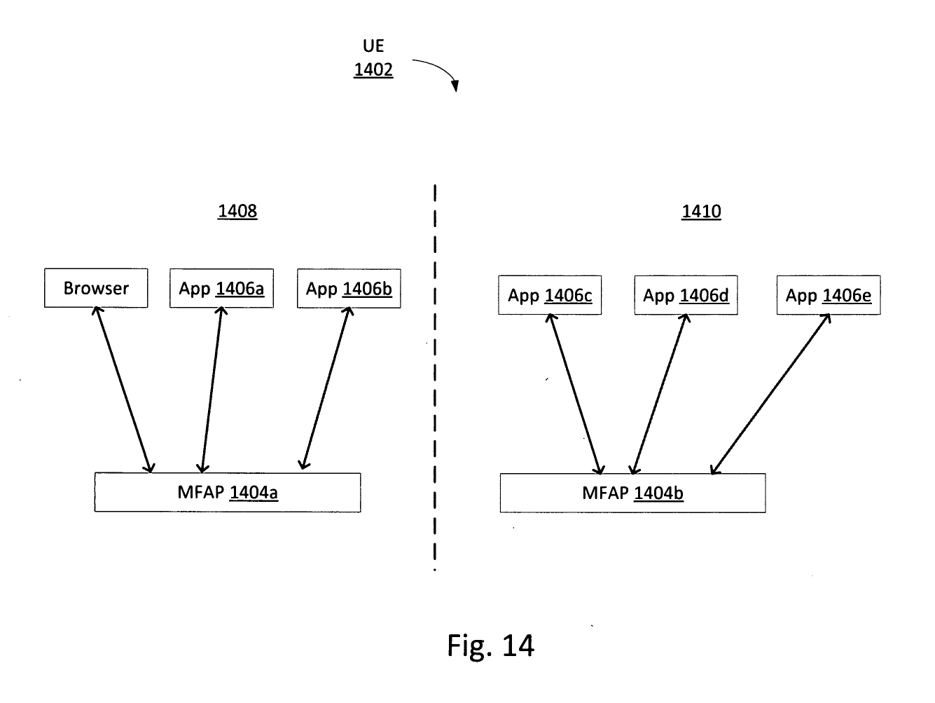

Referring now to FIG. 14, a device, for instance a UE 1402 may have one or more multi-factor authentication proxies (MFAPs), for instance a first MFAP 1404a and a second MFAP 1404b, associated with different Multi-Factor Authentication Servers. Thus, the UE 1402 may have multiple applications, for instance a first application 1406a, a second application 1406b, a third application 1406c, a fourth application 1406d, and a fifth application 1406e, which are each associated with different security domains. Each MFAP may be associated with its own MFAS. For example, in accordance with the example depicted by FIG. 14, the first MFAP 1404a may be associated with a user's personal workspace 1408, and thus may be associated with the user's personal identity provider (IdP), and the second MFAP 1404b may be associated with an IdP that is part of a user's work (enterprise) space 1410. Each of the first and second MFAPs may its own associated AT value. Also, a subset of apps may be associated with first MFAP 1404a and another subset of apps may be associated with the second MFAP 1404b. In accordance with the illustrated example, the first and second apps 1406a and 1406b are associated with the first MFAP 1404a, and the third, fourth, and fifth apps 1406c-e are associated with the second MFAP 1404b. It will be understood that a plurality of the MFAPs may reside within the same space, or the MFAPs may reside in different workspaces within the UE 1402 as shown in FIG. 14. As shown, the first MFAP 1404a resides in the personal workspace 1408, and the second MFAP 1404b resides within the enterprise workspace 1410. Thus, each MFAP of a given UE may reside within its own security domain.

An example of using multiple MFAPs within a user device and the respective AT is shown in Tables 2 and 3.

TABLE 2

| Applications | Alreq | AT selected |
|---|---|---|
| App1 | Medium | Low |
| App2 | Low | |

From Table 1, it can be observed that the application App1 has an ALreq=“Medium,” while App2 has ALreq=“Low”. The AT that has been selected and configured is “Low”. Therefore, at any instance, the user is authenticated on a continuous basis in order to maintain an Assurance level=low and thereby, the user is able to access App2 seamlessly without requiring any additional authentication. However, if a user requires access to App1, then an extra level of authentication may have to be carried out because it requires an ALreq=Medium.

TABLE 3

| Applications | ALreq | AT selected |
|---|---|---|
| App3 | High | Medium |
| App4 | High | |
| App5 | Medium | |

As it can be observed from Table 3, which depicts a different example scenario, the apps App3 and App4 have ALreq=High, while App5 has ALreq=Medium, and the AT that has been selected and configured is “Medium”. Therefore, at any instance, the user is able to access App5 without requiring additional authentication. However, if the user were to access App3 or App4, the user may have to be authenticated using certain factors of authentication so that the cumulative Authentication Assurance Level achieved is equal to or greater than “High”.

The MFAP 1404a and the MFAP 1404b may share a common API in order to access the various devices/device drivers that might be required to initiate authentication factors and/or obtain results of explicit or implicit authentications. However, the interpretations of the assurance levels associated with each of the authentication factors may be dependent upon the MFAP/MFAS or the security domains to which they belong. The MFAP 1404a and the MFAP 1404b (or any additional MFAP) may belong to different security domains, and therefore have different policies that interpret the assurance levels differently.

In some cases, it is the presence of user-controlled devices and their configuration/interworking with each other that creates yet another environmental authentication factor which can be continuously monitored. Such continuously monitored environmental authentication factor can be used as one of the additional authentication factors (e.g., location, relevant location, time of access, etc.) by employing its own MFAS/MFAP.

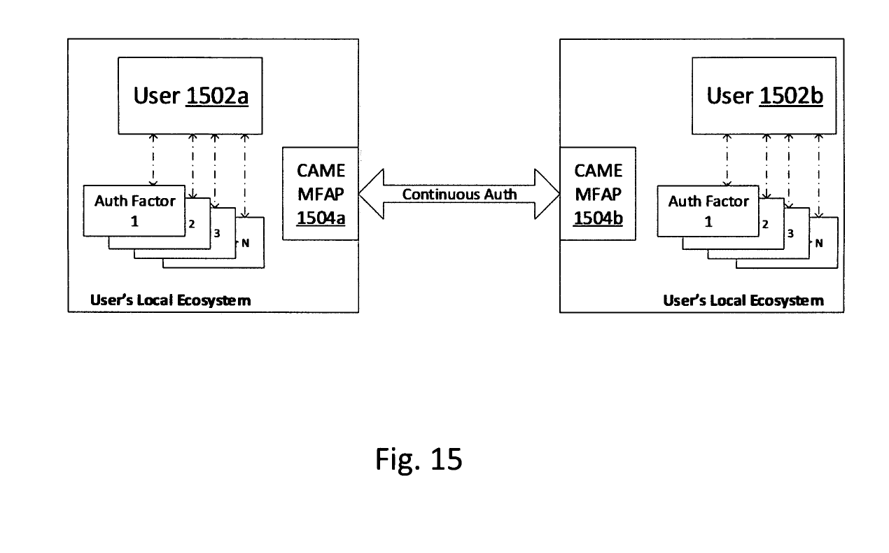

Referring now to FIG. 15, a first user 1502a (e.g., a parent) and a second user 1502b (e.g., the parent's child) would like to be in constant communication, and would like to be periodically or continuously authenticated with one another. In this scenario, the two user entities 1502a and 1502b need not use an application for communication, but may use the CAME framework in order to vouch to one another using continuous authentication mechanisms (e.g., implicit means) that the entities 1502a and 1502b are who they are.

In one example, the MFAPs within each of the UEs associated with each user performs continuous authentication of one another. For example, a first MFAP 1504a associated with the first user/UE 1502a may act as the master MFAP, and a second MFAP 1504b may act as a slave MFAP. In other embodiment, the users 1502a and 1502b may belong to a group, and thus their authentications may be performed using group mechanisms described above. For example, MFAPs that reside in each of the group member's UEs can perform continuous authentication of one another. Alternatively, a transitive approach may be used. By way of example, if User A is continuously authenticated with User B, and if User C is continuously authenticated with User B, then User A might not need to be continuously authenticated by User C. Thus, User A and User C may have the same assurance level with one another, even though they are not being directly authenticated with one another.

Thus, as described above, an authentication assurance level associated with a first entity (e.g., a UE) may be computed by a second entity (e.g., a CAME), wherein the authentication assurance level changes, for instance decays, as a function of time. The computed authentication assurance level may be compared to an authentication threshold that is based on a network policy. Based on the comparison, it can be determined whether a fresh performance of at least one of a plurality of different authentication factors is required to satisfy the authentication threshold. In response to determining that the fresh performance of one of a plurality of different authentication factors is required, at least one authentication factor may be invoked. Furthermore, the authentication assurance level, as described above, may be computed using at least one of the plurality of different authentication factors that have respective authentication assurance levels that change over time. The authentication assurance level associated with the first entity may be computed periodically. Alternatively, or additionally, the authentication assurance level may be computed in response to an event. The CAME may include a server-side continuous authentication server (CAS) that communicates with the first entity over a network, and a continuous authentication agent (CAA) that resides locally on the first entity. The first entity may be registered with a multi-factor authentication server (MFAS), such that authentication capabilities associated with the first entity can be retrieved from the MFAS.

In one example, the authentication assurance level decays linearly as a function of time. Alternatively, the authentication assurance level may decay exponentially as a function of time. Alternatively still, the authentication assurance level may decay in accordance with a step function that reduces to zero after a period of time. The plurality of authentication factors may each have a corresponding parameter indicative of how the assurance level contribution for each factor changes, for instance decays, over time.

FIG. 16A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 16A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 16A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 16A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 16A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 16A may be configured to communicate with the base station 64a, which may employ a cellular-based radio technology, and with the base station 64b, which may employ an IEEE 802 radio technology.

FIG. 16B is a system diagram of an node, such as a node that is implemented in FIGS. 1 and 3-10, for instance a UE, AP, or WTRU 52. As shown in FIG. 16B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 16B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 16B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 68 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 68 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 16C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 16C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 16C, the Node-Bs 90a, 90b may be in communication with the RNC 94. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 56 shown in FIG. 16C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
computing an authentication assurance level associated with a first entity, wherein the authentication assurance level changes as a function of time;
comparing the computed authentication assurance level to an authentication threshold that is based on a network policy;
based on the comparison, determining that a fresh performance of at least one of a plurality of different authentication factors is required to satisfy the authentication threshold;
selecting an authentication factor from the plurality of different authentication factors; and
in response to determining that the fresh performance of at least one of a plurality of different authentication factors is required, invoking the selected authentication factor, such that the authentication threshold is satisfied.

2. (canceled)

3. The method as recited in claim 1, wherein the authentication assurance level is computed using the selected authentication factor that has authentication assurance level that changes over time.

4. The method as recited in claim 1, the method further comprising periodically computing the authentication assurance level associated with the first entity.

5. The method as recited in claim 1, the method further comprising computing the authentication assurance level in response to an event.

6. The method as recited in claim 1, wherein the steps of the method are performed by a second entity in communication with the first entity.

7. The method as recited in claim 3, wherein the second entity comprises a server-side continuous authentication server (CAS) that communicates with the first entity over a network, and a continuous authentication agent (CAA) that resides locally on the first entity.

8. The method as recited in claim 1, wherein the authentication assurance level decays linearly as a function of time.

9. The method as recited in claim 1, wherein the authentication assurance level decays exponentially as a function of time.

10. The method as recited in claim 1, wherein the authentication assurance level decays in accordance with a step function that reduces to zero after a period of time.

11. The method as recited in claim 1, wherein the first entity is registered with a multi-factor authentication server (MFAS), such that authentication capabilities associated with the first entity can be retrieved from the MFAS.

12. The method as recited in claim 1, wherein the plurality of authentication factors each have a corresponding parameter indicative of how the assurance level contribution for each factor changes over time.

13. A first entity comprising communication circuitry such that the first entity is communicatively coupled with a second entity via its communication circuitry, wherein the first entity further comprises:
a processor and a memory, the memory containing computer-executable instructions that when executed by the processor, cause the processor to perform operations comprising:
computing an authentication assurance level associated with the second entity, wherein the authentication assurance level changes as a function of time;
comparing the computed authentication assurance level to an authentication threshold that is based on a network policy;
based on the comparison, determining that a fresh performance of at least one of a plurality of different authentication factors is required to satisfy the authentication threshold;
selecting an authentication factor from the plurality of different authentication factors;
in response to determining that the fresh performance of at least one of a plurality of different authentication factors is required, invoking the selected authentication factor authentication factor, such that the authentication threshold is satisfied.

14. (canceled)

15. The entity as recited in claim 13, wherein the authentication assurance level is computed using the selected authentication factor that has an authentication assurance level that changes over time.

16. The entity as recited in claim 13, the operations further comprising periodically computing the authentication assurance level associated with the second entity.

17. The entity as recited in claim 13, the operations further comprising computing the authentication assurance level in response to an event.

18. The entity as recited in claim 13, wherein the first entity further comprises a server-side continuous authentication server (CAS) that communicates with the first entity over a network, and a continuous authentication agent (CAA) that resides locally on the first entity.

19. The entity as recited in claim 13, wherein the authentication assurance level decays linearly as a function of time.

20. The entity as recited in claim 13, wherein the authentication assurance level decays exponentially as a function of time.

21. The entity as recited in claim 13, wherein the authentication assurance level decays in accordance with a step function that reduces to zero after a period of time.

22. The entity as recited in claim 13, wherein the second entity is registered with a multi-factor authentication server (MFAS), such that authentication capabilities associated with the second entity can be retrieved from the MFAS.
